(19) United States
(12) Patent Application Publication
(10) Pub. No.: US 2026/0312808 A1
(43) Pub. Date: Oct. 8, 2026

(54) METHOD FOR EXCHANGING A SECRET WHICH CAN WITHSTAND QUANTUM COMPUTER ATTACKS, AND ASSOCIATED COMPUTER SYSTEM AND COMPUTER PROGRAM

(71) Applicant: BE YS TRUSTED SOLUTIONS FRANCE, Clermont-Ferrand (FR)

(72) Inventor: David NACCACHE, PARIS (FR)

(73) Assignee: BE YS TRUSTED SOLUTIONS FRANCE, Clermont-Ferrand (FR)

(21) Appl. No.: 18/996,492

(22) PCT Filed: Jul. 20, 2023
(86) PCT No.: PCT/FR2023/051128

§ 371 Date: Jan. 27, 2025

(30) Foreign Application Priority Data
Jul. 20, 2022 (FR) FR2207432

(51) Int. Cl. H04L 9/30; H04L 9/00

(52) U.S. Cl. CPC H04L 9/3073; H04L 9/002

(57) ABSTRACT

The invention relates to a method (KEM) for transporting a secret resistant to quantum computer attacks. Such a transport method (KEM) according to the invention consists of methods respectively for generating general parameters, generating secret and public keys, and encapsulating and decapsulating said secret to be transported. Such a secret transport method is arranged to be implemented by a computer system comprising a plurality of electronic devices seeking to establish a secure communication channel using said secret carried to establish a session key. The invention further relates to such a computer system and any computer program whose program instructions, once recorded in memories of the plurality of electronic devices of the system, cause the implementation of a method (KEM) for transporting a secret according to the invention.

The invention relates to the field of cryptology.

More specifically, the invention relates to methods for transporting a secret which can withstand quantum computer attacks, such methods consisting of methods for generating parameters, for generating keys, for encapsulating (encrypting) keys and for decapsulating (decrypting) encrypted keys. The invention moreover relates to any computer system containing a plurality of electronic devices each containing a central processing unit which controls a memory through signals, as well as an input unit and an output unit, implementing any one of said methods for generating parameters, for generating keys, for encapsulating (encrypting) keys and for decapsulating (decrypting) encrypted keys. One of the preferred fields of use of such an invention relates to secure communications between electronic devices of such a computer system, these latter using a key or more generally a secret exchanged via an insecure communication channel which can withstand quantum computer attacks owing to the implementation of said methods for generating parameters, for generating keys, for encapsulating (encrypting) keys and for decapsulating (decrypting) keys encrypted by said computer system.

To describe the invention clearly, it is necessary to introduce notations and to recall the following concepts, which are known to a person skilled in the art:
“public-key cryptography”;
“post-quantum cryptography”;
the “knapsack problem (also denoted by the acronym KP)”;
the use of the “LLL” algorithm in order to divide the information;
“key encapsulation mechanisms”, also denoted by the acronym “KEM”.

Unless otherwise specified, lowercase letters with an arrow on top denote vectors. For example, \vec{x^{[n]}}denotes a vector of n elements \vec{x^{[n]}}={x₁, . . . , xₙ}.

Scalar operations on vectors are to be interpreted as acting on the components of the vectors. For example, the elements of the vector \vec{y=^{[n]}}=a\vec{x^{[n]}}+b mod c are defined by the relationship yᵢ=axᵢ+b mod c, while the elements of \vec{z^{[n]}}=\vec{x^{[n]}} mod \vec{y^{[n]}} are zᵢ=xᵢ mod yᵢ for i=1, . . . , n.

The usual scalar product will be denoted

$$\vec{{a}^{[ n ]}} \cdot \vec{{b}^{[ n ]}} := {\sum }_{i = 1}^{n} {a}_{i} {b}_{i} .$$

The operator “·” involving vectors with a dimension greater than 1 will be denoted

$$\vec{{z}^{[ t ]}} = \vec{{x}^{[ n ]}} \cdot \text{?} = \text{?} \cdot \vec{{x}^{[ n ]}} = \{ \vec{{x}^{[ n ]}} \cdot \vec{{y}_{1}^{[ n ]}} , … , \vec{{x}^{[ n ]}} \cdot \vec{{y}_{t}^{[ n ]}} \} ,$$

where \vec{x^{[n]}}={x₁, . . . , xₙ} is a vector with n coordinates and [symbol] is a vector with t coordinates each having n coordinates, namely:

$$\text{?} = \{ \vec{{y}_{1}^{[ n ]}} , … , \vec{{y}_{t}^{[ n ]}} \}$$

$$where$$

$$\vec{{y}_{1}^{[ n ]}} = \{ {y}_{i , 1} , … , {y}_{i , n} \} .$$

Thus:

$$\begin{matrix}\vec{{z}^{[ t ]}} = \vec{{x}^{[ n ]}} \cdot \vec{{\vec{{y}^{[ n ]}}}^{[ t ]}} \\ = \vec{{\vec{{y}^{[ n ]}}}^{[ t ]}} \cdot \vec{{x}^{[ n ]}} \\ = \{ \vec{{x}^{[ n ]}} \cdot \vec{{y}_{1}^{[ n ]}} , … , \vec{{x}^{[ n ]}} \cdot \vec{{y}_{t}^{[ n ]}} \} \\ = \{ {\sum }_{i = 1}^{n} {x}_{i} {y}_{1 , i} , … , {\sum }_{i = 1}^{n} {x}_{i} {y}_{t , i} \} \\ = \{ {z}_{1} , … , {z}_{t} \} .\end{matrix}$$

Other usual and useful notations used in the present document are given in the following table:

| Notation | Meaning |
|---|---|
| = | Mathematical identity |
| := | Relationship definition |
| ← | Assignment of a value to a variable |
| ${x ← X}^{\$}$ | Assign to x a value taken randomly from the set X |
| OWF(x) | Any one-way function (unspecified) |
| HASH(x) | Any cryptographic hash function (unspecified) |
| PRNG(x) | Pseudorandom number generator initialized with a seed equal |
| | to x |
| O(f) | Time complexity of the function f |
| Õ(f) | Complexity O(f) ignoring logarithmic factors |
| N | The set of natural integers |
| Z | The set of integers |
| Z_{q} | Ring of integers modulo q > 0 |
| ${Z}_{q}^{*}$ | Z_{q} without the element 0 |
| Pₓ | The set of prime numbers with a size of x bits |
| a\|b | The concatenation of the binary numbers a and b. |
| a ⊕ b | Or exclusively of the binary numbers a and b. |

The invention belongs to the category of asymmetric cryptographic methods also called “public-key cryptographic methods”.

These are algorithms and protocols which make a secure communication possible between the entity which encrypts the message, called sender and generally denoted by the reference S in the present document, and the entity which decrypts it, called recipient and generally denoted by the reference R in the present document. Initially, R and S do not share a common secret key.

Asymmetric cryptography defines two keys: a public key pk known by everyone and a private key sk kept confidential by the recipient R.

The encryption algorithm f is assumed to be accessible to all the potential senders S desiring to communicate with the recipient R.

The decryption algorithm f⁻¹ is also assumed to be accessible to everyone and public.

A computer program, the program instructions of which cause the implementation of the algorithms f and f⁻¹ by any computer or electronic device arranged to store said computer program in a memory, can be published without fear for the security of said communication.

Thus, any entity S desiring to send a message m in an encrypted manner to a particular recipient R can use the public key pk of the recipient R in order to create an encrypted c intended for R. Only R will be capable of decrypting c.

In a public-key encryption algorithm, the sender S encrypts the message m using said encryption algorithm f to obtain an encrypted c=f(pk,m), using said public key pk of said recipient R. Conversely, the recipient R of the message m decrypts the encrypted c by applying said decryption algorithm f⁻¹. This latter f⁻¹ is such that m=f−(sk, c), where sk is the secret key linked to the public key pk held by said recipient R.

Said public pk and secret sk keys are generated using a randomized algorithm called “parameter generation algorithm” and a randomized algorithm called “key generation algorithm”, which will be discussed in the following. Sometimes, and this is the case in the present invention, the parameter generation algorithm and the key generation algorithm are merged into a single algorithm.

Thus, the fundamental identity of the asymmetric encryption is m=f⁻¹(sk, f (pk, m)).

For example, a well-known public-key encryption algorithm f is the algorithm called RSA described in the American patent U.S. Pat. No. 4,405,829 and in the associated publication R. L. Rivest, A. Shamir, and L. M. Adleman, “A Method for Obtaining Digital Signatures and Public-key CryptoSystems”, Communications of the ACM, volume 21, no. 2, pages 120 to 126, 1978.

Algorithms are also known which use elliptic curves (for example such as disclosed by the article N. Koblitz, “Elliptic-Curve Cryptosystems”, Mathematics of Computation, volume no. 48, pages 203 to 209, 1987, or the article by V. Miller entitled “Use of Elliptic Curves in Cryptography”, CRYPTO 85, 1985) or else the Diffie-Hellman key exchange described in the American patent U.S. Pat. No. 4,200,770. These algorithms have the drawback of requiring very cumbersome modular calculations, but above all they have the drawback of not being able to withstand attacks carried out using equipment of a new type: quantum computers.

Quantum computing emerged at the beginning of the 1980s. Rather than being restricted to the limits of electronic circuits and electricity, quantum computing functions according to the principles of quantum physics, which is why it is proving to be capable of processing very complex mathematical problems so effectively. It could one day accomplish feats of which conventional computing is proving to be quite simply incapable. The development of quantum computers has been slow, but the pace is quickening now thanks to academic and industry efforts aiming to standardize encryption methods which can withstand quantum attacks.

The majority of the current public-key encryption techniques are based on algorithms which integrate difficult problems originating from number theory, such as factorization or calculation of the discrete logarithm. Designed in 1976, the previously mentioned RSA encryption, according to which each recipient R has a public key pk and a private key sk, constitutes the precursor of almost all the modern encryption schemes. To send a confidential message to this recipient R, the data m of said message are encoded in the form of a large integer and scrambled using the public key pk corresponding to the private key sk held by said recipient R to whom the sender S desires to communicate said message m, to form an encrypted c. The recipient R who receives said encrypted c can then decrypt this latter by means of their private key sk. In RSA encryption, the public key pk is in the form of a large composite number n, and an exponent e, often equal to three. The private key sk is characterized by the prime factors of n.

By means of specific algorithms known to a person skilled in the art (such as, for example, the Shor's algorithm described in the document P. W. Shor (1994). “Algorithms for quantum computation: discrete logarithms and factoring”. Proceedings 35th Annual Symposium on Foundations of Computer Science. IEEE Comput. Soc. Press: pp. 124-134), a quantum computer having enough q-bits (“quantum bits”) could factorize large numbers. Within the framework of RSA encryption, an adversary having a quantum computer could start from a public key pk, factorize n in order to obtain the private key sk, and thus read the content of any encrypted c whatever. This ability to factorize the numbers practically wipes out the whole of modern cryptography. The repercussions associated with this attack tool are proving to be considerable, because in the context of the internet the omnipresent security in our methods of communicating and sharing information online is based on public-key encryption.

Thus, if an adversary managed to obtain a quantum computer, they could theoretically cause total chaos. They would be able to create encryption certificates and pose as a bank in order to steal funds, disrupt cryptocurrency technology, break into digital wallets, as well as spy on and decrypt confidential communications.

An encryption algorithm capable of withstanding an adversary equipped with a quantum computer belongs to the category of “post-quantum algorithms”.

Thus, an important aim of the present invention is to provide a post-quantum encryption method which can withstand attacks carried out using quantum computers.

It is intellectually appealing to base a public-key cryptography algorithm on the so-called “knapsack” problem, denoted by the acronym KP hereafter. In fact, this problem is considered to be very difficult to solve. It forms part of the class of the most difficult problems to solve with a computer: the NP-complete problems. In broad outline, such a problem comes back to virtually choosing objects from a plurality of objects with possibly different weights to fill a knapsack so that it has a particular weight once it has been filled.

In its most basic form, called “decision”, the KP consists of stating whether a target integer b can be expressed as the sum of a subset of a given set of integers A={a₁, . . . , a₁}∈Nⁿ.

In other words, given a set of positive integers A and a target b∈N as inputs, the decision KP consists of stating whether there is or is not a sequence of bits {x₁, . . . , xₙ} that satisfies

$${\sum }_{i = 1}^{n} {x}_{i} {a}_{i} = b .$$

Despite its apparent simplicity, the decision KP is NP-complete, as explained in the document M. R. Garey and D. S. Johnson, “Computers and Intractability: A Guide to the Theory of NP-Completeness”, W. H. Freeman, 1979, ISBN 0-7167-1044-7. This property makes the KP particularly interesting for cryptographic constructions.

Effectively, the prior art in cryptography used the KP for such purposes.

The KP also exists in a version called “computational”, which consists not only of stating whether there is a sequence of bits {x₁, . . . , xₙ} but also of explicitly finding (discovering) it.

Historically, Merkle and Hellman proposed (cf. M. R. Garey and D. S. Johnson, “Computers and Intractability: A Guide to the Theory of NP-Completeness”, W. H. Freeman, 1979, ISBN 0-7167-1044-7) one of the first cryptosystems based on the computational KP. Several other cryptosystems based on KP have been proposed over decades but, unfortunately, a large number of these cryptosystems have been broken, as explained in the document A. M. Odlyzko, “The rise and fall of knapsack cryptosystems”, Cryptology and computational number theory, vol. 42, pp. 75-88, 1990.

In fact, while random instances of the KP are difficult to solve, the need to be able to decrypt (i.e. to reverse the addition process) forces the designers to introduce specific mathematical structures into the KPs used in this way. It is the introduction of these specific structures, which differentiates cryptographic KPs from random KPs, that ultimately made it possible to break them.

A very important parameter making it possible to control the difficulty of solving a KP instance is its density. The density is defined as the ratio Δ between n and the size of the largest of the aᵢ. More specifically, Δ can be denoted

$$Δ := n / ( {log}_{2} {max}_{i} {a}_{i} ) .$$

When Δ<0.94, there are rapid algorithms, called “polynomial-time”, making it possible to solve the KP, see the document M. J. Coster, A. Joux, B. A. LaMacchia, A. M. Odlyzko, C-P. Schnorr and J. Stern, “Improved Low-Density Subset Sum Algorithms, Computational Complexity”, vol. 2, pp. 111-128, 1992.

In particular, random KP instances can be reformulated as a problem of approximation of the shortest vector in a network, as stipulated by the documents by J. C. Lagarias and A. M. Odlyzko, “Solving Low-Density Subset Sum Problems”, J. ACM, vol. 32, no. 1, pp. 229-246, 1985” and by A. M. Frieze, “On the Lagarias-Odlyzko Algorithm for the Subset Sum Problem”, SIAM J. Comput., vol. 15, no. 2, pp. 536-539, 1986. When the density is low (Δ<0.94, as explained in the document by M. J. Coster, A. Joux, B. A. LaMacchia, A. M. Odlyzko, C-P. Schnorr and J. Stern, “Improved Low-Density Subset Sum Algorithms, Computational Complexity”, vol. 2, pp. 111-128, 1992), there are effective algorithms finding such short vectors. These algorithms then make it possible to solve the KP, as explained in different documents, including:
V. Lyubashevsky, “The Parity Problem in the Presence of Noise, Decoding Random Linear Codes, and the Subset Sum Problem, Approximation, Randomization and Combinatorial Optimization, Algorithms and Techniques”, 8th International Workshop on Approximation Algorithms for Combinatorial Optimization Problems, APPROX 2005 and 9th International Workshop on Randomization and Computation, RANDOM 2005, Berkeley, CA, USA, Aug. 22-24, 2005, Proceedings, pp. 378-389, 2005;
Y. Desmedt, “Knapsack Cryptographic Schemes”, Encyclopedia of Cryptography and Security, 2nd Ed, pp. 695-704, 2011;
E. F. Brickell, “Solving Low Density Knapsacks”, Advances in Cryptology, Proceedings of CRYPTO'83, Santa Barbara, California, USA, Aug. 21-24, 1983, pp. 25-37, 1983.

Insofar as densities A greater than 1 do not guarantee that there is a single solution to the KP, the range of densities that can be used to construct knapsacks which are both invertible and high-density is within the relatively reduced range of values 0.94<Δ<1 (cf. R. Impagliazzo and M. Naor, “Efficient Cryptographic Schemes Provably as Secure as Subset Sum”, J. Cryptology, vol. 9, no. 4, pp. 199-216, 1996). This range only leaves a small leeway for the design of cryptosystems but has an advantage from the point of view of security because the only algorithms that make it possible to solve KPs within this range have exponential complexity (as explained in the following documents N. Howgrave-Graham and A. Joux, “New Generic Algorithms for Hard Knapsacks”, Advances in Cryptology—EUROCRYPT 2010, 29th Annual International Conference on the Theory and Applications of Cryptographic Techniques, Monaco/French Riviera, May 30-Jun. 3, 2010. Proceedings, pp. 235-256, 2010 or else A. Becker, J-S. Coron and A. Joux, “Improved Generic Algorithms for Hard Knapsacks”, Advances in Cryptology—EUROCRYPT 2011-30th Annual International Conference on the Theory and Applications of Cryptographic Techniques, Tallinn, Estonia, May 15-19, 2011. Proceedings, pp. 364-385, 2011), requiring an execution time which expands in Õ(2^{0.291n}). The object of the invention is actually to propose a novel method based on such dense knapsacks.

Finally, post-quantum cryptosystems based on networks such as those described in the documents cited hereafter are also based on the difficulty of solving KPs.

The following documents describing such encryption methods may be mentioned:
M. Ajtai and C. Dwork, “A Public-Key Cryptosystem with Worst-Case/Average-Case Equivalence”, Proceedings of the Twenty-Ninth Annual ACM Symposium on the Theory of Computing, El Paso, Texas, USA, May 4-6, 1997, pp. 284-293, 1997;
O. Regev, “On lattices, learning with errors, random linear codes, and cryptography”, J. ACM, vol. 56, no. 6, pp. 34:1-34:40, 2009;
O. Regev, “New lattice-based cryptographic constructions”, J. ACM, vol. 51, no. 6, pp. 899-942, 2004;
Ch. Peikert, “Public-key cryptosystems from the worst-case shortest vector problem: extended abstract”, Proceedings of the 41st Annual {ACM} Symposium on Theory of Computing, STOC 2009, Bethesda, MD, USA, May 31-Jun. 2, 2009, pp. 333-342, 2009.
V. Lyubashevsky, A. Palacio and G. Segev, “Public-Key Cryptographic Primitives Provably as Secure as Subset Sum”, Theory of Cryptography, 7th Theory of Cryptography Conference, TCC 2010, Zurich, Switzerland, Feb. 9-11, 2010. Proceedings, pp. 382-400, 2010.

A method making it possible to divide the information in a modular equation is the algorithm called “LLL”, published by A. K. Lenstra, H W. Lenstra, and L. Lovász, (1982) “Factoring polynomials with rational coefficients”—Mathematische Annalen. 261 (4): 515-534.

Let x₁, . . . , xₖ∈N^{k} be a collection of k integer unknowns. Let p∈N be a modulus and let a₀, . . . , aₖ∈N^{k}. The knapsack equation

$${a}_{0} = {\sum }_{i = 1}^{k} {a}_{i} {x}_{i} mod p$$

is considered.

It is known to a person skilled in the art that said LLL algorithm makes it possible to find x₁, . . . , xₖ when

$${\sum }_{i = 1}^{k} binary\_size ( {x}_{i} ) = binary\_size ( p ) .$$

In particular, the LLL algorithm can be adapted in order to provide any uneven division of sizes between the xᵢ when the size of p is equal to the sum of the sizes of the xᵢ.

A detailed theoretical analysis of the LLL algorithm and the way in which LLL can be put to good use in order to effect such a division of the information is given in the document by Ph.Q. Nguyen and J. Stern, “The Two Faces of Lattices in Cryptology”, Cryptography and Lattices, International Conference, CaLC 2001, Providence, RI, USA, Mar. 29-30, 2001, Revised Papers, pp. 146-180, 2001” and in Chapter 13 of the document by A. Joux, “Algorithmic cryptanalysis”, 2009, CRC Press, in the context of generalized KPs.

A typical example of the use of this information division technique in a cryptanalysis context can be found in the document by M. Beunardeau, A. Connolly, R. Geraud and D. Naccache, “On the Hardness of the Mersenne Low Hamming Ratio Assumption”, Cryptology ePrint Archive, Report 2017/522, 2017, https://ia.cr/2017/522. For example, it is possible to divide the information in the modular equation y+Ax+B=0 mod n by finding a solution x, y where one of the unknowns has a size of log₂n−q bits and the other has a size of q bits, as illustrated by the following script in the Mathematica language (formal computation software released by Wolfram Research) requiring the information to be divided according to a ratio of 20%-80%.

```
LLL := Function[{n, A, B, q},
      Take[LatticeReduce[{{ n\hat{ }2 , 1, 0, 0, 0, 1 }, { n\hat{ }2 A, 0, 1, 0, 0,
        Floor[n/2\hat{ }(2 q)]}, { n\hat{ }3, 0, 0, 0, 0, 0}, { n\hat{ }2 B, 0, 0,
        n\hat{ }2 , 1, 0}}][[4]], {2, 3}]];
{n, A, B} = {1022237686736673601670114674799,
  1132435774382335446239287364640,
  1138052122014831676258469648193};
Print[{{y, x} = LLL[n, A, B, 20], Mod[y + A x + B, n] == 0,
    N[Log[2, Abs[{x, y, n}]]]}]
```

This script effectively gives: {{-314929374373641319630381,822627},True,{19.6499,78.0594,99.6896}}

In cryptology, a Key Encapsulation Mechanism or KEM (sometimes also called “key transport”) is a protocol that makes it possible to securely transmit a session key K to the recipient R by means of an insecure channel. The encapsulation of such a key K is one of the components of a hybrid cryptography scheme, the other being the encapsulation of data (by means of the key K transmitted in this way). The encapsulation serves the same function as a key-transport protocol, except that the key K here is generated entirely by the sender S, which makes it possible, among other things, to start to transmit the encrypted data to R directly with the encapsulated key K.

The encapsulation mechanisms standardized by the ISO/IEC 18033-26 standard, known to a person skilled in the art, include RSA-OAEP and RSA-KEM.

As a general rule, the key encapsulation mechanism consists of encrypting a random key K by a second electronic device S of a computer system, by means of a public key pk dedicated to a first recipient electronic device R. The encrypted C is transmitted to said first electronic device R, this latter being responsible for decrypting said encrypted C by means of its private key sk. The sender S and the recipient R then have one and the same shared secret K, allowing a secure communication. Thus, any public-key encryption immediately gives a key encapsulation mechanism and vice versa. In practice, it is also necessary to protect the encapsulated key K against manipulations, for example by adding to it a redundancy or an authentication code.

The following scenario is considered, in which a sender S generates an encapsulated key K and sends it to a recipient R. A KEM is translated into four successive processes, respectively for (1) generating general parameters, (2) for generating the secret and public keys of the recipient R, this latter being published, (3) for encapsulating then transmitting, by the sender S (on the basis of said general parameters par and the public key pk of the recipient R), the key K encapsulated in this way for the attention of the recipient R, and (4) for decapsulating or recovering this latter by said recipient R.

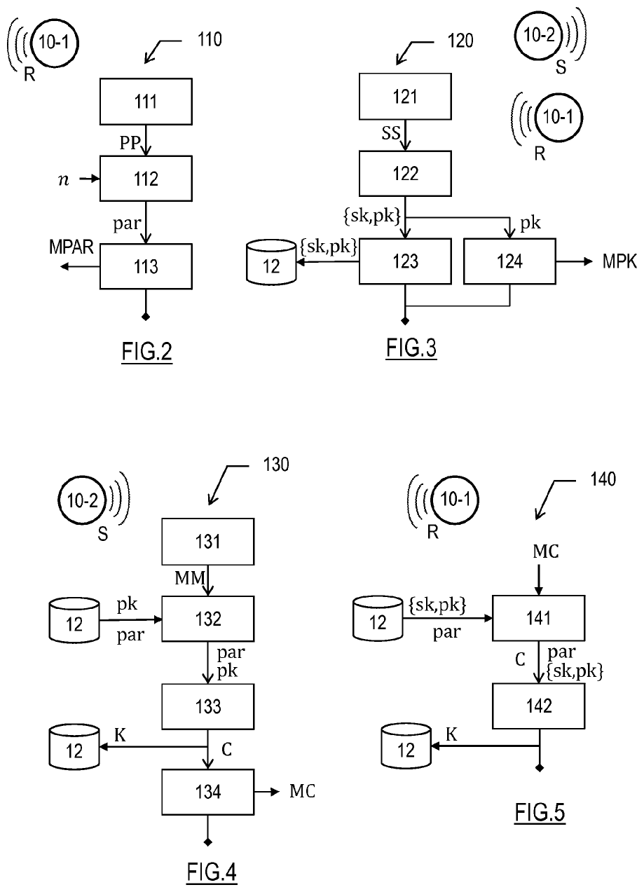

These four successive processes, which will be described later in the form of the methods 110, 120, 130 and 140 in conjunction with FIGS. 2 to 5, respectively implement four algorithms, which may be denoted by the terms AlgSetUp, AlgKeyGen, Encap, Decap, as indicated by the notation KEM:=(AlgSetUp, AlgKeyGen, Encap, Decap), and consist of the following sequence of steps:
the recipient R generates, for example, general parameters, denoted par, necessary for the operation of the KEM, as summarized by the relationship par←AlgSetUp;
said recipient R generates a private key sk and a published public key pk, as summarized by the relationship {sk, pk}←AlgKeyGen(par);
for their part, the sender S uses par and pk to produce a key K, which they keep confidential, and an encrypted C encapsulating said secret key K to be transmitted to the recipient R, as summarized by the relationship {C,K}←Encap(par,pk); at the end of this step, the encrypted C is sent to the recipient R;
said recipient R receives the encrypted C and recovers the encapsulated key K from this latter, as summarized by the relationship K←Decap(par, sk, C) by implementing the decapsulation algorithm Decap; if said decapsulation step has not been successful, the algorithm Decap may return an “error” message.

At the end of this sequence, R and S share the same secret session key K.

Of the numerous advantages provided by the present invention, it may be mentioned that:
the information that any potential attacker would seek to take on the basis of the public key is reduced as much as possible. In fact, the invention keeps the modulo modulus which the KP calculations have effected hidden. In doing so, it is reasonably conjectured that the invention protects the proposed cryptosystem against network-based attacks which target modular KPs;
a KEM according to the invention resists quantum attacks because said KEM is based neither on the factorization problem nor on the discrete logarithm problem, which are both vulnerable to quantum attacks;
a KEM according to the invention is particularly optimized and high-performance since the algorithms implemented within the framework of the invention require few operations to store and execute the algorithms Encap and Decap, thus uniting high performance of execution and preservation of the storage capacity of the equipment implementing the KEM; in addition, the number of instructions of the code necessary for carrying out the invention in terms of software or the number of logic gates necessary for carrying out the invention in terms of hardware is very small;
the RAM (Random-access memory) necessary for executing said algorithms Encap and Decap is also small in relation to the prior art, thus also preserving the resources of said equipment implementing a KEM according to the invention;
the bandwidth necessary for exchanges between equipment implementing a KEM according to the invention is considerably increased in relation to the prior art, since, to securely exchange a key K of k bits, a KEM according to the invention requires a maximum transmission of O(k) bits, where the conventional algorithms require O(k²), thus again increasing the performance of said KEM according to the invention in relation to the prior art; it should be noted that a KEM according to one of the embodiments of the invention makes it possible to transmit tk bits of key instead of k, where typically t≤4.
according to preferred embodiments, the invention also provides being able to compress the public key pk and/or the private key sk, such that the hardware resources necessary for implementing such a KEM are preserved even more.

From a theoretical and practical point of view, a great advantage of the invention is that the parameter p (which will be discussed later) remains secret. Thus, an adversary is not faced with a modular KP but with an integer KP, which is much more difficult.

For this purpose, the invention first of all provides a method for transporting a secret K which can withstand quantum computer attacks, said method being implemented by a computer system containing a first and a second electronic device, said first and second electronic devices each containing a processing unit which cooperates with a data memory and means of communication with the outside world, said first electronic device R being designed to receive and use the previously produced secret K encapsulated by said second electronic device S, said transport method including:
a step of generating and publishing general parameters par of said transport method implemented by the first electronic device R;
a step of generating a pair {sk, pk} of secret and public keys, as well as of publishing said public key produced, said step being implemented by the first electronic device R, said pair of secret and public keys {sk, pk} being produced on the basis of said general parameters par and on the basis of a first random data item produced by a random number generator of said first electronic device R;
a step of encapsulating the secret K in the form of an encrypted C and of transmitting this latter, said step being implemented by said second electronic device S on the basis of said general parameters par, the public key pk of said first electronic device R and a second random data item produced by the random number generator of said second electronic device S;
a step of decapsulating said secret K implemented by said first electronic device R on the basis of said encrypted C, said general parameters par and the pair {sk, pk} of secret and public keys already produced by the first electronic device R.

To be able to withstand a quantum computer attack, said second random data item serves to derive a vector of n integers \vec{m^{[n]}} and in that the step of encapsulating the secret K in the form of an encrypted C and of transmitting this latter consists of implementing two sums having the same indices m₁, . . . , mₙ, the encrypted C consisting of a first sum such as C←\vec{m^{[n]}}·\vec{v^{[n]}} and the secret K consisting of a second sum, called “mirror sum”, such as K←\vec{m^{[n]}}·\vec{s^{[n]}}, said first sum being calculated in a first algebraic structure, said second sum being calculated in a second algebraic structure and the vectors \vec{v^{[n]}} and \vec{s^{[n]}} being extracted from the public key pk of said first electronic device R.

The invention provides different variants, according to which:
said first and second algebraic structures are the ring of integers Z;
said first and second algebraic structures are finite fields;
said first algebraic structure is the ring of integers Z and said second algebraic structure is a finite field;
said first algebraic structure is a finite field and said second algebraic structure is the ring of integers Z.

According to a first embodiment of a KEM according to the invention that is safe against chosen-plaintext attacks (CPA-safe):
the step of generating and publishing general parameters par consists of determining an integer n such that k≤n, k being a security parameter, par being defined by the pair par={n, k};
the step of generating a pair {sk, pk} of secret and public keys, as well as of publishing said public key pk produced consists of:
   using the first random data item in order to derive the following parameters:
      an integer p of n bits;
      a prime integer q of k bits;
      integers d and μ such that

$$( d , μ ) {←}^{\$} {Z}_{p}^{*} \times {Z}_{q}^{*} ;$$

a vector \vec{w^{[n]}} of n positive integers w₁, . . . ,wₙ the sum of which is limited by p;
producing the secret key sk←{p, d, μ};
producing the public key pk←{q, \vec{v^{[n]}}, \vec{s^{[n]}}}, the vectors \vec{v^{[n]}} and \vec{s^{[n]}} being defined by the two relationships \vec{v^{[n]}}←\vec{w^{[n]}}d⁻¹ mod p and \vec{s^{[n]}}←\vec{w^{[n]}}μ mod q.
the step of encapsulating the secret K consists of using the second random data item in order to produce a vector of n integers \vec{m^{[n]}}, on the basis of which the encrypted C←\vec{m^{[n]}}·\vec{v^{[n]}} and the key K←\vec{m^{[n]}}·\vec{s^{[n]}} mod q are calculated;
the step of decapsulating the secret K consists of recovering the key K such that K←μb mod q, where b←Cd mod p.

According to this first embodiment, the vector \vec{w^{[n]}}=w₁, . . . ,wₙ can be produced by the following sequence of operations:
\vec{w^{[n]}}←Ø;
while said vector \vec{w^{[n]}} does not contain n distinct elements, do:

$$\vec{{u}^{[ n ]}} {←}^{\$} {( {Z}_{p}^{*} )}^{n} ;$$

\vec{r^{[n]}}←Sort (\vec{u^{[n]}}) according to the criterion rᵢ≤rᵢ₊₁, for 1≤i≤n−1;
w₁←r₁ and wᵢ←rᵢ−rᵢ₋₁ for 2≤i≤n.

According to a second embodiment, to further strengthen the robustness of a KEM according to the invention, it is possible for the component q of the public key pk not to be revealed to the second electronic device S. For this:
the step of generating and publishing general parameters par consists of determining an integer n such that k≤n, k being a security parameter, par being defined by the pair par={n, k};
the step of generating a pair {sk, pk} of secret and public keys, as well as of publishing said public key pk produced consists of:
   using the first random data item in order to derive the following parameters:
      an integer p of n bits;
      a prime integer q of k bits;
      integers d and μ such that

$$( d , μ ) {←}^{\$} {Z}_{p}^{*} \times {Z}_{q}^{*} ;$$

a vector \vec{w^{[n]}} of n positive integers w₁, . . . , wₙ, the sum of which is limited by p and such that

$${\sum }_{i = 1}^{n} ( μ {w}_{i} mod q ) < q ;$$

producing the secret key sk←{p, d,μ};
producing the public key pk←{q, \vec{v^{[n]}}, \vec{s^{[n]}}}, the vectors \vec{v^{[n]}} and \vec{s^{[n]}} being defined by the two relationships \vec{v^{[n]}} \vec{w^{[n]}}d⁻¹ mod p and \vec{s^{[n]}}←\vec{w^{[n]}}μ mod q;
the step of encapsulating the secret K consists of using the second random data item in order to produce a vector of n integers \vec{m^{[n]}}, on the basis of which the encrypted C←\vec{m^{[n]}}·\vec{v^{[n]}} and the key K←\vec{m^{[n]}}·\vec{s^{[n]}} are calculated;
the step of decapsulating the secret K consists of recovering the key K such that K←μb mod q, where b←Cd mod p.

To reduce the sizes of the keys {sk,pk}, a method according to the invention can be adapted such that:
the step of generating and publishing general parameters par consists of determining an integer n such that k≤n, k being a security parameter, par being defined by the pair par={n, k};
the step of generating a pair {sk, pk} of secret and public keys, as well as of publishing said public key pk produced consists of:
   using the first random data item in order to produce two seeds

$$( seed\_pk , seed\_sk ) {←}^{\$} {[ 0 , {2}^{k} - 1 ]}^{2} ;$$

producing the secret key sk←{p, d, μ}, where

$$p ∈ {P}_{n} , d ∈ {Z}_{p}^{*} and μ ∈ {Z}_{q}^{*}$$

are derived deterministically from seed_sk;
producing the public key pk←{q, \vec{v′^{[n]}}+\vec{z^{[n]}},\vec{s^{[n]}}}, where:
   the vector \vec{v′^{[n]}}∈[1, 2ⁿ−1]ⁿ is derived deterministically from seed_pk;
   q is a prime number of k bits derived deterministically from seed_pk;
   the vector \vec{z^{[n]}} and the vector \vec{s^{[n]}} being produced by the following method:

$$\vec{{z}^{[ n ]}} {←}^{\$} {[ 1 , {n}^{2} - 1 ]}^{n} ;$$

for 1≤i≤n, do:
while (v′ᵢ+zᵢ) d mod p≥[p/n], refresh

$${z}_{i} {←}^{\$} [ 0 , {n}^{2} - 1 ] ;$$

\vec{s^{[n]}}←μ((\vec{v′^{[n]}}+\vec{z^{[n]}})d mod p) mod q;
compressing the key pk into {seed_pk,\vec{z^{[n]}},\vec{s^{[n]}}};
the step of encapsulating the secret K consists of:
   decompressing {seed_pk,\vec{z^{[n]}}, \vec{s^{[n]}}} by deriving the vector \vec{v′^{[n]}} from the seed_pk then forming \vec{v^{[n]}}:=\vec{v′^{[n]}}+\vec{z^{[n]}};
   generating, on the basis of the second random data item, a vector of n integers \vec{m^{[n]}}, on the basis of which the encrypted C←\vec{m^{[n]}}·\vec{v^{[n]}} and the key K←\vec{m^{[n]}}·\vec{s^{[n]}} mod q are calculated;
the step of decapsulating the secret K consists of recovering the data sk:={p, d, μ} on the basis of seed_sk then of recovering the key K such that K←μb mod q, where b←Cd mod p.

According to an advantageous embodiment, p can be prime or such that GCD(d, p)=1.

To optimize the bandwidth necessary for implementing a method according to the invention, and transmit longer keys, the method according to the invention can be adapted such that:
the step of generating and publishing general parameters par consists of determining an integer n such that k≤n, k being a security parameter and a non-zero integer t, said general parameters par being the triplet {t, n, k};
the step of generating a pair {sk, pk} of secret and public keys, as well as of publishing said public key pk consists of producing, on the basis of the first random data item, the following data items:
   an integer q of k bits;
   a vector

$$\vec{{p}^{[ t ]}} ← \{ {p}_{1} , … , {p}_{t} \} {←}^{\$} {P}_{n}^{t}$$

with i≠j⇒pᵢ≠pⱼ;
a vector

$$\vec{{d}^{[ t ]}} ← \{ {d}_{1} , … , {d}_{t} \} {←}^{\$} {Z}_{{p}_{1}}^{*} \times … \times {Z}_{{p}_{t}}^{*} ;$$

a random invertible matrix M with a dimension of t×t, the elements of which are taken randomly from Z_{q};
a secret key sk←{\vec{p^{[t]}},\vec{d^{[t]}}, M};
a public key

$$p k ← \{ q , \vec{{v}^{[ n ]}} , \text{?} \} ,$$

the vectors \vec{v^{[n]}} and [symbol] being produced such that:
\vec{v^{[n]}}←{v₁, . . . , vₙ} verifies the condition ∀i,j, 0<vᵢ<2ⁿ and dⱼvᵢ mod pⱼ<pⱼ/n;

$$\text{?} = \{ \vec{{s}_{1}^{[ n ]}} , … , \vec{{s}_{t}^{[ n ]}} \} ← M \cdot \text{?} , where$$

$$\text{?} ← \{ \vec{{v}^{[ n ]}} {d}_{1} mod {p}_{1} , … , \vec{{v}^{[ n ]}} {d}_{t} mod {p}_{t} \} ;$$

the step of encapsulating the secret \vec{K^{[t]}} consists of using the second random data item in order to produce a vector of n integers \vec{m^{[n]}}, on the basis of which the encrypted C←\vec{m^{[n]}} \vec{v^{[n]}} and the key \vec{K^{[t]}}:=\vec{m^{[n]}}{right arrow over (s^{[n]}^{^{[t]}}←{\vec{m^{[n]}})}·

$$\vec{{s}_{1}^{[ n ]}} mod q , … , \vec{{m}^{[ n ]}} \cdot \vec{{s}_{t}^{[ n ]}} mod q \}$$

are calculated;
the step of decapsulating the secret \vec{K^{[t]}} consists of recovering (141) the key \vec{K^{[t]}} such that \vec{K^{[t]}}←M \vec{b^{[t]}} mod q, where \vec{b^{[t]}}←C \vec{d^{[t]}} mod \vec{p^{[t]}}.

According to an advantageous embodiment, t can be smaller than or equal to 4.

In the same way, an advantageous embodiment can consist of the fact that n can be such that n>3.44k.

For an additional security, the steps of encapsulating and decapsulating the secret K, respectively \vec{K^{[t]}}, can include applying a one-way function OWF(x) to said secret K (respectively \vec{K^{[t]}}) to produce a second secret K′=OWF(K) (respectively K′=OWF (\vec{K^{[t]}}) used effectively instead of K (respectively \vec{K^{[t]}}) by an application implementing the KEM, i.e. for cryptographic purposes. In fact, such an additional protection destroys any algebraic properties remaining in K (respectively \vec{K^{[t]}}).

According to a second subject, the invention relates to a computer program product containing one or more program instructions that can be executed by the processing unit of a computer, said program instructions being able to be loaded into a memory of said computer and the execution of which by said processing unit causes the implementation of a method for transporting a secret K which can withstand quantum computer attacks according to the invention.

According to a third subject, the invention relates to a computer-readable storage medium containing the instructions of such a computer program product.

According to a fourth subject, the invention relates to a computer system containing a plurality of electronic devices each comprising a processing unit and a memory, said memory of each of said electronic devices comprising the program instructions of a computer program product according to the invention.

Other characteristics and advantages will become more clearly apparent on reading the following description and examination of the accompanying figures, in which:

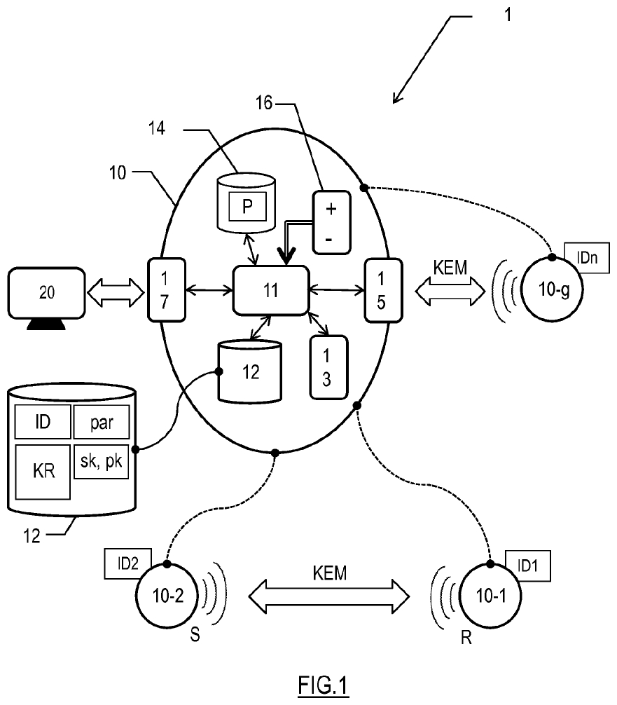

FIG. 1 illustrates an example of a computer system containing a plurality of electronic devices implementing a key-transport method according to the invention;

FIG. 2 illustrates an example of a functional method for producing general parameters of a key-transport method according to the invention;

FIG. 3 illustrates an example of a functional method for generating public and private keys implemented by any electronic device of a computer system according to the invention;

FIG. 4 illustrates an example of a functional session key encapsulation method implemented by any electronic device of a computer system according to the invention desiring to share said session key with another electronic device of said computer system;

FIG. 5 illustrates an example of a functional session key decapsulation method implemented by any electronic device of a computer system according to the invention receiving a session key encapsulated by another electronic device of said computer system.

It is normal to define the following security concepts for KEMs:
a KEM:=(AlgSetUp, AlgKeyGen, Encap, Decap) is “(1−λ) correct” if ∀pk,sk ∈AlgKeyGen,Pr[Decap(sk, C)=K:(C, K)←Encap(pk)]≥1−λ. In particular, a KEM is “perfectly correct” if λ=0;
a KEM:=(AlgSetUp, AlgKeyGen, Encap, Decap) is safe against chosen-plaintext attacks (CPA-safe) if, for any distinguishing algorithm being executed in a polynomial time, given {par, pk}, the advantage of distinguishing (C, K₀) from (C, K₁), where (C, K₀)←Encap(pk) and where K₁ is chosen uniformly and independently of C, is negligible;
A KEM:=(AlgSetUp, AlgKeyGen, Encap, Decap) is safe against chosen-ciphertext attacks (CCA-safe) if, for any distinguishing algorithm being executed in a polynomial time and having access to a decapsulation oracle and to {par, pk}, the advantage of distinguishing (C, K₀) from (C, K₁), where (C, K₀)←Encap(pk) and where K₁ is chosen uniformly and independently of C, is negligible, while the distinguisher is restricted to never asking the oracle to decrypt C.

According to particular characteristics, any one of the devices for generating parameters, for generating keys, for encapsulating (encrypting) keys and for decapsulating (decrypting) encrypted keys described briefly above can be realized in the context of an electronic circuit.

Such an electronic circuit can, for example, be constituted by a microprocessor, by a programmed circuit (also sometimes called FPGA, for “Field Programmable Gate Array”) or by a hardwired logic chip (also sometimes called ASIC, for “Application Specific Integrated Circuit”).

The invention is also aimed at a fixed, or partially or totally removable, data storage means, containing computer program code instructions for executing the steps of any one of the methods for generating parameters, for generating keys, for encapsulating (encrypting) keys and for decapsulating (decrypting) encrypted keys, according to the invention. The invention is also aimed at a computer program that can be downloaded from a communication network and/or stored on a computer-readable medium and/or can be executed by a microprocessor containing the program instructions which, when they are executed, by the computer or the microprocessor, cause the implementation of a KEM according to the invention.

This computer program is remarkable in that it comprises instructions for executing the steps of any one of the above-described methods for generating parameters, for generating keys, for encapsulating (encrypting) keys and for decapsulating (decrypting) encrypted keys, when it is executed on a computer or in a microprocessor. Other aspects and advantages of the invention will become apparent on reading the detailed description below of particular embodiments, given by way of non-limitative examples.

The construction concept of a KEM system according to the invention will now be illustrated.

In other words, it will be shown how to construct the algorithm which will be used to process a data block according to the invention. It will be noted that the choice of the functions or numerical values in the examples included is essentially aimed at simplifying the disclosure and is not intended to reflect advantageous values in terms of a practical implementation of the invention.

As indicated above, the present invention also relates to a computer system containing a plurality of communicating electronic devices implementing any one of the above-described methods for generating parameters, for generating keys, for encapsulating (encrypting) keys and for decapsulating (decrypting) encrypted keys.

As indicated by FIG. 1, this computer system 1 contains a plurality of electronic devices 10-1, 10-2, . . . , 10-g. Conventionally, each electronic device consists of an instance of an electronic device 10 containing a central processing unit 11 controlling, through signals carried by a communication bus represented in FIG. 1 by single-line double arrows, electronic elements including a data memory 12 and a program memory 14, said memories 12 and 14 being able to form only one and the same physical entity. Such an electronic device 10 can contain a random number generator 13, this latter potentially being able to form one and the same physical entity with said processing unit 11.

By “memory” is meant any computer memory, whether volatile or not. A non-volatile memory is a computer memory the technology of which retains its data in the absence of an electrical power supply. It can contain data resulting from inputs, calculations, measurements and/or program instructions. The main non-volatile memories currently available are electrically writable such as EPROM (“Erasable Programmable Read-Only Memory”) technology or also electrically writable and erasable such as EEPROM (“Electrically-Erasable Programmable Read-Only Memory”), flash, SSD (“Solid-State Drive”) technologies, etc. Non-volatile memories are distinguished from memories called “volatile”, the data of which are lost in the absence of an electrical power supply. The main volatile memories currently available use the RAM (“Random Access Memory”), DRAM (dynamic random access memory, requiring regular refreshing), SRAM (static random access memory, requiring such a refresh when there is an undersupply of electrical power), DPRAM or VRAM (particularly suitable for video) technologies, etc.

An electronic device 10 moreover contains means for communication 15 with the outside world in the form of an input unit and an output unit. Said communication means 15 cooperate with the processing unit 11 and ensure a wireless or wired proximity communication with any other electronic device of said computer system 1. To function, i.e. in order that the processing unit 11 implements a method according to the invention, an electronic device 10 generally contains an electrical power source 16 in the form of one or more batteries for example. Such an electrical power source 16 can be internal or external to said electronic device 10. The processing unit 11 can also contain control means 17 for a human-machine input and/or output interface 20. Throughout the document, by “human-machine output interface” is meant any device, used alone or in combination, making it possible to output or deliver a representation that is graphical, haptic, acoustic or more generally perceptible to humans. Such a human-machine output interface can consist, non-exhaustively, of one or more screens, speakers or other suitable alternative means. By “human-machine input interface” is meant a computer keyboard, a pointing device, a touchscreen, a microphone or, more generally, any interface arranged to translate a gesture command or an instruction given by a human into control or configuration data. Advantageously, the human-machine input and output interfaces can constitute only one and the same physical entity.

Such a computer system 1 can be adapted by loading, into the program memory 14 of each electronic device 10-1, 10-2, . . . , 10-g, a computer program P containing instructions to cause, when they are executed, the implementation of a method for generating parameters, for generating keys, for encapsulation and/or for decapsulation according to the invention. This program can use any programming language whatever, and can be in the form of source code, object code, or intermediate code between source code and object code, such as in an interpreted, partially or completely compiled, form or in any other desirable form whatever.

As indicated previously, to be able to exchange a secret via an insecure communication channel which can withstand quantum computer attacks, one of the electronic devices of the computer system 1 described in conjunction with FIG. 1, for example the electronic device 10-1, implements a method 110 for generating parameters par via the execution of a previously mentioned algorithm AlgSetUp. The electronic device 10-1 can be the future recipient R of a secret K, which will be communicated to it by an electronic sender device S of said computer system 1, such as the electronic device 10-2, or else can consist of any other electronic device 10-2, . . . , 10-g whatever of said system 1.

FIG. 2 thus describes a process flowchart for such a method 110 implemented by an electronic device of a computer system 1, such as the electronic device 10-1, R receiving a secret.

Such a method 110 takes, as input, a security parameter k and includes a step 112 of generating the parameters par necessary for implementing a KEM according to the invention. Such a method can include a prior step 111 of producing a first random or pseudorandom data item PP by the random or pseudorandom number generator 13, all or some of said parameters par being able to be produced on the basis of said first random or pseudorandom data item PP. Said method 110 can include a step 113 to cause the output, by the communication means 15, of a message MPAR intended for all or some of the electronic devices 10-2, . . . , 10-g of the computer system 1 conveying said parameters par. When such a message MPAR is received, said electronic devices 10-2, . . . , 10-g record the values of said parameters par in their respective data memories 12.

FIG. 3 describes a process flowchart for a method 120 for generating keys implemented by any electronic device of a computer system 1, such as the electronic device 10-1, R receiving a secret, via the execution of a previously mentioned algorithm AlgKeyGen.

Such a method 120 includes a step 121 of producing a second random or pseudorandom data item SS by the random or pseudorandom number generator 13 and a step 122 of generating the keys {sk, pk} using said second random or pseudorandom data item SS. Said method 120 then includes a step 123 of recording the values of said keys {sk, pk} in the data memory 12 of the electronic device R, 10-1, implementing said method 120. Said method 120 moreover includes a step 124 to cause the output of a message MPK intended for all or some of the electronic devices 10-2, . . . , 10-g of the computer system 1, said message MPK conveying said public key pk. When such a message is received, said electronic devices 10-2, . . . , 10-g record the value of said public key pk in their respective data memories 12, advantageously in a data structure KR associating these latterwith identifiers ID1, . . . , IDg characterizing the electronic devices that have published their keys.

The invention provides, when the methods 110 and 120 are implemented consecutively by one and the same electronic device of said computer system 1, that the parameters par which were produced in step 112 of the method 110 can be conveyed jointly with the public key pk by the message MPK, the output of which by the communication means 15 is caused by step 124 of the method 120.

FIG. 4 describes a process flowchart for a method 130 for encapsulating a secret K implemented by an electronic device of a computer system 1, such as the electronic device S, 10-2, via the execution of a previously mentioned algorithm Encap. Such an electronic device S, 10-2 can desire to send said secret K in the form of an encrypted C intended for the single electronic device R, 10-1 having implemented the method 120, as described previously in conjunction with FIG. 3.

A method 130 includes a step 131 of producing a third random or pseudorandom data item MM by the random or pseudorandom number generator 13 and a step 133 of generating an encrypted C of a secret K which it is desired to produce and thus to encapsulate to be communicated securely, using said third random or pseudorandom data item MM, the parameters par and the public key pk of the electronic device R, 10-1 receiving said encrypted. For this, said method 130 includes a step 132, prior to step 133, of reading the data memory 12 to know the value of said public key pk of said recipient R, 10-1. Said method 130 then includes a step 134 of triggering the output of a message MC conveying said encrypted C intended for the electronic device R, 10-1 of the computer system 1 conveying said encrypted. In this case, according to the example illustrated by FIG. 1, such a method 130 can be implemented by the electronic device 10-2 acting as sender S of said encrypted C for the attention of the electronic device R, 10-1 designated by the selection 132 of the public key pk of this latter as the only recipient of said encrypted C and capable of being able to decrypt it, as will be examined in conjunction with FIG. 5.

Said FIG. 5 thus describes a process flowchart for a method 140 for decrypting the encrypted C or for decapsulating a secret K implemented by an electronic device of a computer system 1, such as the electronic device R, 10-1, via the execution of a previously mentioned algorithm Decap. Such a method 140 is implemented in response to the receipt of a message MC conveying an encrypted C produced by a third-party electronic device according to an encapsulation or encryption method 130 described previously in conjunction with FIG. 4.

Such a method 140 includes a first step 141 of reading, in the data memory 12, the respective values of the public key pk and of the secret key sk previously produced in step 122 of a method 120 already described in conjunction with FIG. 3. As said public pk and secret sk keys are specific to the electronic device R, 10-1 receiving the encrypted C, said keys are respectively denoted pk and sk in FIG. 5. Said step 141 also uses the parameters par, transmitted in steps 112 and/or 123. Such a step 141 moreover consists of reading, in said data memory 12, the values of the parameters par previously produced by a method for generating parameters such as the method 110, already described in conjunction with FIG. 2 and implemented by the present electronic device R, 10-1 or by a third-party electronic device.

A method 140 also includes a step 142 of producing said secret K which it is desired to take from the encrypted C received. Such a decapsulation step 142 is performed on the basis of said encrypted C, the parameters par and the public pk and secret sk keys of the electronic device R (10-1) receiving said encrypted C. In this case, according to the example illustrated by FIG. 1, such a method 140 can be implemented by the electronic device 10-1 acting as recipient R of said encrypted C sent by the electronic device 10-2 acting as sender S.

All of the cryptosystems based on KP have the aim of finding the vector \vec{m^{[n]}} in the formula

$$C = {Σ}_{i = 1}^{n} {v}_{i} {m}_{i}$$

or a certain modulus in an equivalent modulo formula.

The general inventive concept deviates from this architecture by introducing at least two KPs denoted: \vec{v^{[n]}} and \vec{s^{[n]}}.

Here, \vec{v^{[n]}} and \vec{s^{[n]}} act as a KP coupled with a “mirror KP”. The sender S (10-2) generates \vec{m^{[n]}} at random and calculates at least two sums C and K, where sᵢ=φ(vᵢ) for a certain function φ(x), the parameters of which are unknown to it. Said two sums being

$$C = {Σ}_{i = 1}^{n} {v}_{i} {m}_{i} and K = {Σ}_{i = 1}^{n} {s}_{i} {m}_{i} .$$

The sum K serves as shared secret. The sum C is the encrypted conveying K.

It will be noted that, contrary to the conventional KEMs based on the KP, here it is not \vec{m^{[n]}} but K that is transferred. The recipient R (10-1) applies to C a method Φ such that

$$Φ ( C ) = Φ ( {Σ}_{i = 1}^{n} {v}_{i} {m}_{i} ) = {Σ}_{i = 1}^{n} ϕ ( {v}_{i} ) {m}_{i} = {Σ}_{i = 1}^{n} {s}_{i} {m}_{i} = K .$$

It will also be noted that different \vec{m^{[n]}} can result in one and the same K and that in practice this is effectively the case. Thus, it is seen that the core of the invention is the development of functions Φ and φ having the above-required property.

Some examples of such methods which can be combined with each other are described.

According to a first example, called “modular calculations” and denoted Φ₁, if vᵢ=psi mod q is assumed, then, provided that a size condition on the vᵢ is respected and/or provided that q is disclosed, the function Φ₁ consists of reducing C modulo q and dividing the result by μ modulo q. The addition of a constant, namely vᵢ=μᵢsᵢ+μ₂ mod q, makes it possible, if the Hamming weight of \vec{m^{[n]}} is a fixed parameter, to add more variability into Φ₁. The subtraction of two such vᵢ will eliminate μ₂ and cancel its effect, but if such an operation is combined and stacked in the following blocks Φᵢ, its effect will be preserved. It will also be noted that there is nothing to prevent several different modular calculations, modulo q from being stacked in each other. For example, if vᵢ=μ′₁(μ₁sᵢ+μ₂ mod q)+μ′₂ mod q′ is assumed.

Thus, vᵢ+vⱼ=μ′₁(μ₁sᵢ+μ₂ mod q)+μ′₁(μ₁sⱼ+μ₂ mod q)+2μ′₂ mod q′.

This makes it possible, by subtracting 2μ′₂ modulo q′ and by dividing by μ′₁ modulo q′, to “unstack” the quantity (μ₁sᵢ+μ₂ mod q)+(μ₁sⱼ+μ₂ mod q) mod q′.

It is then seen that, if there are n terms in such an addition, the choice nq<q′ makes it possible to find the quantity (μ₁sᵢ+μ₂ mod q)+(μ₁sⱼ+μ₂ mod q) in Z. A subtraction of the constant 2μ₂ modulo q and a modular division by μ₁ will give the sum sᵢ+sⱼ modulo q or the sum in Z if the sum of the sᵢ does not exceed q. It is obvious to a person skilled in the art that different stages can thus be stacked.

According to a second example, called “concatenation with a random variable” and denoted Φ₂, vᵢ=rᵢ|0^{u}|sᵢ is taken, where the rᵢ are random numbers, and the notation 0^{u} denotes a sequence of u=[log₂ n] bits equal to 0. By adding at most n such as vᵢ, the quantity

$${Σ}_{i = 1}^{n} {v}_{i} = {Σ}_{i = 1}^{n} {r}_{i} \vert {Σ}_{i = 1}^{n} {s}_{i}$$

will be obtained, which makes it possible to cut the top part of the number and find the sum of the sᵢ.

A third example, called “cut and permute” and denoted Φ₃, is examined. It is also noted that the sᵢ can be cut into two or more bitstreams sᵢ[j] with an even or uneven size, for example sᵢ=sᵢ[2]|sᵢ[1]. These bitstreams can be permuted according to a known permutation of R (the electronic device 10-1 in FIG. 1) but not of S (the electronic device 10-2 in FIG. 1). In the illustrative example given here, vᵢ=sᵢ[1]|0^{u}|sᵢ[2] can be taken for example, which amounts to inverting the top weights and the bottom weights of the quantity sᵢ (taking care to keep, between sᵢ[1] and sᵢ[2], a “buffer” of u=[log₂ n] bits equal to 0 intended to absorb the carry digit of the addition). By adding at most n such as vᵢ, the quantity

$${Σ}_{i = 1}^{n} {v}_{i} = {Σ}_{i = 1}^{n} {s}_{i} [ 1 ] \vert {Σ}_{i = 1}^{n} {s}_{i} [ 2 ]$$

will be obtained.

This quantity can be easily cut and “put back in the correct order” in order to form the quantity

$${Σ}_{i = 1}^{n} {s}_{i} .$$

Finally, a fourth example, called “linear combinations with internal key” and denoted Φ₄, is examined. Take vᵢ=rᵢ|0^{u}|(sᵢ+rᵢ), where the rᵢ are random numbers. By adding at most n such as vᵢ, the quantity

$${Σ}_{i = 1}^{n} {v}_{i} = {Σ}_{i = 1}^{n} {r}_{i} \vert {Σ}_{i = 1}^{n} ( {s}_{i} + {r}_{i} )$$

will be obtained.

This makes it possible to cut the top part of the number and find the sum

$${Σ}_{i = 1}^{n} {s}_{i} = {Σ}_{i = 1}^{n} ( {s}_{i} + {r}_{i} ) - {Σ}_{i = 1}^{n} {r}_{i} .$$

Note that confidential constants σ₁ and σ₂ can embellish the relationship: vᵢ=rᵢ|0^{u}|(σ₁sᵢ+σ₂rᵢ), thus making it even more complex.

All of these methods Φᵢ to construct the vᵢ can be combined with each other and can give rise to a multitude of functions Φ, φ, in a manner that is obvious to a person skilled in the art. The definition of Φ, φ forms part of the private key of R (for example, the electronic device 10-1 in FIG. 1). As this definition can be encoded in the form of a binary number denoted skₑₓₜ seen as an extension of sk describing the configuration and the composition of different transforms Φᵢ, φᵢ leading to the encoding of \vec{s^{[n]}} into \vec{v^{[n]}}. As the Φᵢ, φᵢ can, non-limitatively, be chosen from the transforms which have just been seen. In the following, particular functions Φ,φ will be chosen by way of illustration and non-limitatively.

A first embodiment of a KEM according to the invention is described through one of the respective arrangements of the methods 110, 120, 130 and 140 mentioned previously in conjunction with FIGS. 2 to 5. This first embodiment is called is safe against chosen-plaintext attacks (CPA-safe), it will be called KEMCPA.

According to this first embodiment of a KEM according to the invention, the parameters par produced by a method for generating parameters 110 simply consist of fixing the sizes of the keys used by the methods for generating the keys 120, for encapsulation 130 and for decapsulation 140 implemented in a computer system such as the system 1 according to FIG. 1. More specifically, said parameters par consist of an integer n chosen or predetermined such that k≤n, k being a security parameter. According to a preferred embodiment, n will be chosen in such a way that n>3.44k. The particularly advantageous values for the parameter k are 128, 192 and 256. The values of n which correspond to them being respectively 440, 664, 880. In order to facilitate the implementation using computers or hardware, it is recommended to take the value n approximated to the nearest byte.

The method 120 for generating the public pk and secret sk keys can be summarized by the formula {sk,pk}=AlgGen_{CPA}(n,k). This method 120 implemented by any electronic device 10-1 to 10-g of said computer system 1 includes a step 121 of producing a random or pseudorandom data item SS by the random or pseudorandom number generator 13. Such a random or pseudorandom data item SS makes it possible to derive the elements p, q, d, μ,\vec{w^{[n]}}.

Thus, by way of embodiment example, such a step 121 consists of the following operations:

$$\begin{matrix}( p , q ) {←}^{\$} {P}_{n} \times {P}_{k} ; \\ ( d , u ) {←}^{\$} {Z}_{p}^{*} \times {Z}_{q}^{*} ; \\ \vec{{w}^{[ n ]}} {←}^{\$} \{ \vec{{x}^{[ n ]}} ∈ {N}^{n} , Σ {x}_{i} < p \} .\end{matrix}$$

The step 122 of producing the pair of secret and public keys {sk, pk} can consist of implementing the following operations:

$$\begin{matrix}\vec{{v}^{[ n ]}} ← \vec{{w}^{[ n ]}} {d}^{- 1} mod p ; \\ \vec{{s}^{[ n ]}} ← \vec{{w}^{[ n ]}} {μ}^{- 1} mod q ; \\ sk ← \{ p , d , μ \} ; \\ pk ← \{ q , \vec{{v}^{[ n ]}} , \vec{{s}^{[ n ]}} \} .\end{matrix}$$

Step 121 has been described with prime p of n bits. As a variant, p could be chosen such that GCD(d, p)=1 such that d is invertible.

Furthermore, the operation

$$\vec{{w}^{[ n ]}} {←}^{\$} \{ \vec{{x}^{[ n ]}} ∈ {N}^{n} , Σ {x}_{i} < p \}$$

expressed above can be performed by implementing a routine “RandSumVec” advantageously consisting of a simplified version of the Kraemer algorithm disclosed by N. A. Smith and R. W. Tromble, “Sampling uniformly from the unit simplex”, Johns Hopkins University, Tech. Rep, vol. 29, 2004.

Such a routine can thus consist of first of all initializing the vector \vec{w^{[n]}}=w₁, . . . , wₙ such that \vec{w^{[n]}}←Ø. Then, said routine consists of implementing the following operations:
\vec{w^{[n]}}←Ø;
while said vector \vec{w^{[n]}} does not contain n distinct elements, do:

$$◦ \qquad \vec{{u}^{[ n ]}} {←}^{\$} {( {Z}_{p}^{*} )}^{n} ;$$

\vec{r^{[n]}}←Sort (\vec{u^{[n]}}) according to the criterion rᵢ≤rᵢ₊₁, for 1≤i≤n−1;
w₁←r₁ and wᵢ←rᵢ−rᵢ₊₁ for 2≤i≤n.

By way of illustrative example, such a method 120 (AlgGen_{CPA}) could be expressed in Mathematica language as follows:

```
AlgGenCPA := Function[{n, k},
  {p, q} = RandomPrime[2\hat{ }#] & /@ {n, k};
  {d, \[Mu]} = RandomInteger[#−1] & /@ {p, q};
  w = RandSumVec[p, n];
  v = Mod[PowerMod[d, −1, p] w, p];
  s = Mod[\[Mu] w, q];
  {{p, d, \[Mu]}, {q, v, s}}] ;
```

The routine “RandSumVec” could, for its part, be expressed in Mathematica language as follows:

```
RandSumVec := Function[{p, n},
  w = { };
  While[Length[w] != n,
    r = Sort[Table[RandomInteger[p−1], {i, 1, n}]];
    w = Prepend[Table[r[[i]] − r[[i − 1]], {i, 2, n}], r[[1]]]];
    w];
```

According to this first embodiment of a KEM_{CPA} according to the invention, a method 130 for encapsulating a secret—which can be summarized by the formulation {C, K}=Encap_{CPA}(n, k, pk)—implemented by any electronic device of a computer system 1, such as the electronic device S, 10-2, includes a step 131 of producing a random or pseudorandom data item MM by the random or pseudorandom number generator 13. Such a data item MM makes it possible to derive a vector of n random bits such that

$$\vec{{m}^{[ n ]}} {←}^{\$} {\{ 0 , 1 \}}^{n} .$$

Since the public key pk (read in step 132) of the electronic device receiving the secret K encapsulated in the form of an encrypted C is expressed in the form pk={q, v^{[n]}, s^{[n]}}(cf. the step 122 of generating the keys {sk, pk} of the previously described method 110), the step 133 of generating said encrypted C and the secret K is such that C←\vec{m^{[n]}}·\vec{v^{[n]}}∈N and K←\vec{m^{[n]}}·\vec{s^{[n]}} mod q.

By way of illustrative example, such a method 130 (Encap_{CPA}) could be expressed in Mathematica language as follows:

EncapCPA := Function[{n, k, pk},
{q, v, s} = pk;
m = Table[RandomInteger[1], {i, 1, n}];
{Ch = m . v, K = Mod[m . s, q]}];

According to this first embodiment of a KEM_{CPA} according to the invention, the method 140 for decrypting or decapsulating a secret K, on the basis of which a session key can be created—method 140 which can be summarized by the formulation K=Decap_{CPA}(n, k, sk, pk, C)—implemented by any electronic device of a computer system 1, such as the electronic device R, 10-1, in response to the receipt of a message conveying an encrypted C∈N≤(p−1)<n2ⁿ produced by a third-party electronic device of said computer system 1 according to a previously described encapsulation or encryption method 130, includes a first step 141 of reading, in the data memory 12, the respective values of the public key pk={q, \vec{v^{[n]}}, \vec{s[n]}} and of the secret key sk={p, d, μ} produced previously in step 122 of the method for generating the keys 120 already described in conjunction with FIG. 3, as well as parameters par consisting of the integers n and k such that, advantageously, n>3.44k.

The step 142 of said method 140 consisting of recovering said secret K which it is desired to take from the encrypted C received consists of the operations K←μb mod q, knowing that b←Cd mod p.

By way of illustrative example, such a method 140 (Decap_{CPA}) could be expressed in Mathematica language as follows:

DecapCPA := Function[{n, k, sk, pk, Ch},
{q, v, s} = pk;
{p, d, \[Mu]} = sk;
b = Mod[Ch d, p];
K = Mod[b \[Mu], q]];

It is easy to verify that this KEM_{CPA} (consisting of the methods 110, 120, 130 and 140 described above) according to this first embodiment according to the invention is perfectly correct.

In fact, it is sufficient to verify that \vec{m^{[n]}}·\vec{s^{[n]}} mod q=K=μb mod q.

For this purpose, the definition of b is developed such that b=Cd=\vec{m^{[n]}}·\vec{v^{[n]}}d=\vec{m^{[n]}}·\vec{w^{[n]}}d⁻¹d=\vec{m^{[n]}}·\vec{w^{[n]}} mod p.

It is now possible to verify that \vec{m^{[n]}}=·\vec{w^{[n]}}=Σmᵢwᵢ≤max mᵢΣwᵢ≤1Σwᵢ<p.

Thus, it turns out that \vec{m^{[n]}}·\vec{w^{[n]}} mod p=\vec{m^{[n]}}·\vec{w^{[n]}}, which makes it possible to obtain the value b=\vec{m^{[n]}}·\vec{w^{[n]}}.

This makes it possible to complete the verification K=μb=μ\vec{m^{[n]}}·\vec{w^{[n]}}=\vec{m^{[n]}}·\vec{w^{[n]}}μ=\vec{m^{[n]}}·\vec{s^{[n]}} mod q.

By way of illustrative example, such a correction verification could be expressed in Mathematica language as follows:

n = 500;
k = Floor[n*0.291];
{sk, pk} = AlgGenCPA[n, k];
{Ch, K} = EncapCPA[n, k, pk];
Print[K = = DecapCPA[n, k, sk, pk, Ch]]; K = Mod[b \[Mu], q]];

This first embodiment of a KEM according to the invention is safe against chosen-plaintext attacks (CPA-safe).

The outputs of the thus-obtained method are the following: the size of the private key sk is 2n+k=2.291ⁿ bits, the size of the public key is n(n+k)+k=2.291n²+0.291n bits, the encrypted has a size of n+log₂ n bits and the key K shared between R (10-1) and S (10-2) has a size of k=0.291ⁿ bits.

The realization of the invention has the advantage of being able to be realized using very conventional arithmetic operations. For example, the modular multiplication can be effected using the Montgomery algorithm (described in the publication P. L. Montgomery, “Modular multiplication without trial division”, Mathematics of computation, vol. 44, no. 170, pp. 519-521, 1985.) and/or include the precalculated constants such as described in the publication D. Naccache, D. M'raïhi and D. Raphaeli, (1995). “Can Montgomery parasites be avoided?A design methodology based on key and cryptosystem modifications”. Designs, Codes, and Cryptography, 5(1), pp. 73-80. Advantageously, it would also be possible without risk for security to use a module the form of which facilitates the modular arithmetic or to effect the addition of the integers very rapidly and in parallel using the strategy of representing integers by residues called RNS (“Residue Number System”), for example, such as described in the publication D. Naccache, D. M'Raïhi, W. Wolfowicz and A. di Porto, “Are Crypto-Accelerators Really Inevitable?20 Bit Zero-Knowledge in Less than a Second on Simple 8-bit Microcontrollers”, Advances in Cryptology—{EUROCRYPT} '95, International Conference on the Theory and Application of Cryptographic Techniques, Saint-Malo, France, May 21-25, 1995, Proceeding, Lecture Notes in Computer Science, vol. 921, pp. 404-409, Springer, 1995.

In addition, in order to further reinforce the security of the invention, the following embodiment is proposed: According to this particularly advantageous embodiment of a KEM according to the invention, the algorithms Encap_{CPA} and Decap_{CPA}, i.e. the previously mentioned methods 130 and 140, do not return K directly, but rather K′=OWF(K), OWF(x) being a one-way function. An application using the key, for example an email client encrypting and decrypting the emails exchanged by users, can then use K′ as final encryption key. The idea behind this additional protection is to destroy the remaining algebraic properties of K through the one-way function OWF(x).

The invention also provides adapting such a KEM in order that it is safe against chosen-ciphertext attacks (CCA-safe); it will be called KEM_{CCA}. According to this second implementation example, a conventional transform is applied, such as the one disclosed in the document A. W. Dent, ed. K. G. Paterson, “A Designer's Guide to KEMs”, Cryptography and Coding, 9th IMA International Conference, Cirencester, UK, Dec. 16-18, 2003, Proceedings, Lecture Notes in Computer Science, vol. 2898, pp. 133-151, Springer, 2003 or, alternatively, the one proposed in the document E. Fujisaki and T. Okamoto, “How to Enhance the Security of Public-Key Encryption at Minimum Cost”, Public Key Cryptography, Second International Workshop on Practice and Theory in Public Key Cryptography, PKC '99, Kamakura, Japan, Mar. 1-3, 1999, Proceedings, pp. 53-68, 1999.

The steps 110 and 120 (AlgGen_{CPA}) for producing respectively the general parameters par and the pair of secret and public keys {sk, pk} as mentioned in conjunction with the preceding embodiment are unchanged. In other words AlgGen_{CPA}: =AlgGen_{CCA}. On the other hand, the steps of encapsulation 130 and of decapsulation 140 are adapted. In this respect, the random number generator 13 of the electronic devices of a computer system according to the invention, such as the system 1 according to FIG. 1, is arranged to implement a “seed” PRNG method to pseudorandomly generate the random variables necessary for the implementation of the session key encapsulation method 130. Such a “seed” method can be taken for example from the document by D. J. Bernstein, “The ChaCha family of stream ciphers”, https://cr.yp.to/chacha.html, 2008 or else from the document by J. O'Connor, J.-Ph. Aumasson, S. Neves and Z. Wilcox-O'Hearn, “BLAKE3: one function, fast everywhere”, 2021, https://blake.io.

By way of example, the method 130 as described in conjunction with FIG. 4—which can be summarized in the formulation {C,K}=Encap_{CCA}(n, k, pk)—can consist of the one (Encap_{CPA}) already described in conjunction with the first embodiment, except that the step 131 of producing a pseudorandom data item MM moreover consists of initializing

$${Encap}_{CPA} . PRNG . seed ← {K}_{C C A} {←}^{\$} {\{ 0 , 1 \}}^{k} .$$

Step 133 consists of producing, not the encrypted C which will ultimately be transmitted directly, but a component C₁ thereof, such as C₁←\vec{m^{[n]}}·\vec{v^{[n]}}. Said step 133 moreover consists of producing a second component C₂←K⊕K_{CCA} of said encrypted C. At the end of the implementation of the method 130, the future shared session key is K_{CCA} and the encrypted C transmitted is C:=(C₁, C₂).

By way of illustrative example, such a method 130 (Encap_{CPA}) could be expressed in Mathematica language as follows:

EncapCCA := Function[{n, k, pk, seed},
{q, v, s} = pk;
m = Table[IntegerDigits[Hash[{seed, i}], 2][[1]], {i, 1, n}];
K = Mod[m . s, q];
{{m . v, BitXor[K, seed]}, K}];

A method 140 for decapsulating the secret K_{CCA}—which can be summarized by the formulation K_{CCA}=Decap_{CCA}(n, k, sk, pk, C)—can then consist, on the basis of said encrypted C←(C₁, C₂), of implementing a step 142, as described in conjunction with the first embodiment, on the basis of the general parameters par={n, k}, the secret key sk={p, d, μ}, the public key pk={q, \vec{v^{[n]}},\vec{s^{[n]}}} and the component C₁ of C, recovering the value of the secret K through a simple call-up of K←Decap_{CPA}(n, k, sk, pk, C₁). Said step 142 is then adapted to calculate K_{CCA}←K⊕C₂ and thus recover the random number K_{CCA}. According to this embodiment, such a step 142 must include a test to verify the coherence of K_{CCA} by implementing a processing 133 identical to that implemented by the device sending the encrypted C, the result of this processing having to correspond to the set constituted by the component C₁ and the key K. If negative, the value of K_{CCA} is not confirmed and/or an error is generated.

By way of illustrative example, such a method 140 (Decap_{CCA}) could be expressed in Mathematica language as follows:

DecapCCA := Function[{n, k, sk, pk, Ch},
K = DecapCPA[n, k, sk, pk, Ch[[1]]];
seed = BitXor[K, Ch[[2]]];
If[EncapCCA[n, k, pk, seed] == {Ch, K}, seed, “Error″]];

This allows an execution such as:

n = 100;
k = Floor[n*0.291];
{sk, pk} = AlgGenCPA[n, k];
seed = RandomInteger[2\hat{ }k];
{Ch, K} = EncapCCA[n, k, pk, seed];
Print[DecapCCA[n, k, sk, pk, Ch] == seed];

The outputs of the thus-obtained method are the following: the size of the private key sk is 2n+k=2.291ⁿ bits, the size of the public key is n(n+k)+k=2.291n²+0.291n bits, the encrypted has a size of n+log₂ n+k bits and the key K shared between R, 10-1 and S, 10-2 has a size of k=0.291n bits.

Furthermore, a common practice in cryptography is to decrease the memory space necessary for saving data items and for saving parameters, denoted δᵢ here, by “generating them on the fly”.

Such an on-the-fly generation requires that the data items δᵢ generated on the fly do not have particular mathematical properties. For example, in the case where the δᵢ are public, the δᵢ can be, for example, successive portions of bits, taken from a constant such as π=3.14159 . . . .

It is also common to define, in such a case, δᵢ:=HASH(i, constant), where the (possibly public) “constant” appearing in HASH is a numerical value making it possible to personalize the δᵢ. When the data items δᵢ are confidential data items (typically private keys), it is usual to use a one-way function with a key used in this way: δᵢ:=OWF(i,seed), where “seed” is a confidential data item.

Within the framework of the invention, such constructions will be generically denoted by δᵢ:=Expand(i, x).

Such methods make it possible to generate elements δᵢ in a manner that requires much less memory than is necessary to save the δᵢ literally. Thus, this method makes it possible to considerably decrease the size of the data items δᵢ generated in this way.

In this respect, the invention provides a third embodiment to reduce the size of the secret and public keys {sk, pk} produced in step 120 of a KEM according to the invention, it will be called CompKEM_{CPA}. According to this third embodiment, the steps of encapsulation 130 (Encap_{CPA}) and of decapsulation 140 (Decap_{CPA}) as mentioned in conjunction with the first embodiment can remain unchanged.

The effect of this embodiment on the size of the key is drastic: if the seeds used are each of k′ bits, for KEM_{CPA} and KEM_{CCA} the size of sk falls to k bits, while the size of pk is reduced to k′+n(k+2 log₂ n)=k″+n(0.291n+2 log₂ n). In practice, k′=k will be taken.

The step 120 of producing the secret and public keys {sk, pk} implemented by the first electronic device R, 10-1—which can be summarized by the formulation {sk,pk}=CompAlgGen_{CPA}(n, k)—consists of:
generating a second random data item SS by the random number generator 13 and deriving, from said second random data item SS, two seeds

$$( seed\_pk , seed\_sk ) {←}^{\$} {[ 0 , {2}^{k} - 1 ]}^{2} ;$$

it will be noted that this is the most general description since seed_pk could represent a fixed constant such as π=3.1415 . . . or be derived from the data item PP rather than originating from the random variable SS;
producing the secret key sk←{p, d, μ}, where

$$p ∈ {P}_{n} , d ∈ {Z}_{p}^{*} and μ ∈ {Z}_{q}^{*}$$

being derived deterministically from seed_sk;
producing the public key pk←{q, \vec{v′^{[n]}}+\vec{z^{[n]}}, \vec{s^{[n]}}}, where
   the vector \vec{v′^{[n]}}∈[1, 2ⁿ−1]ⁿ is derived deterministically from seed_pk;
   q is a prime number of k bits derived deterministically from seed_pk;
   the vectors \vec{z^{[n]}} and \vec{s^{[n]}} being produced according to the following method:

$$\vec{{z}^{[ n ]}} {←}^{\$} {[ 1 , {n}^{2} - 1 ]}^{n} ;$$

for 1≤i≤n, do:
   while (v′ᵢ+zᵢ) d mod p≥[p/n], refresh

$${z}_{i} {←}^{\$} [ 0 , {n}^{2} - 1 ] ;$$

\vec{s^{[n]}}←μ((\vec{v′^{[n]}}+\vec{z^{[n]}})d mod p) mod q;
the compressible key \vec{v^{[n]}} is \vec{v^{[n]}}:=\vec{v′^{[n]}}+\vec{z^{[n]}}.

It is recommended to avoid taking, for zᵢ, the smallest value such that (v′ᵢ+zᵢ)d mod p<p/n, because such a choice would cause an information leak: namely that the values lower than zᵢ are not solutions of this inequality. Thus, it is recommended to take a zᵢ from the range [0,n²], or, for an even more strengthened security, from a range [0, n^{τ}] for τ>2. For the choice τ=2, the method CompAlgGen_{CPA} could fail with a probability Γ(n) defined in this way:

$$Γ ( n ) = 1 - {( 1 - {( 1 - \frac{1}{n} )}^{{n}^{2}} )}^{n} ≃ 1 - {( 1 - \frac{1}{{e}^{n}} )}^{n} ≃ n {e}^{- n}$$

Γ(n) is negligible because, with the smallest value of k recommended for use in the present invention, namely k=128, n=440 and therefore Γ(440)≅2⁻¹⁸⁹ are obtained. Thus, it is ensured that a good vector \vec{z^{[n]}} is found which makes it possible to represent \vec{v^{[n]}} using 2n log₂ n bits instead of n² bits.

By way of illustrative example, such a method CompKEM_{CPA} could be expressed in Mathematica language as follows:

```
CompAlgGenCPA := Function[{n, k},
    {seedPK, seedSK} = RandomInteger[2\hat{ }#] & /@ {k, k};
    q = Mod[Hash[{seedPK, 0}], 2\hat{ }k]; While[Not[PrimeQ[q]], q−−];
    p = Mod[Hash[{seedSK, 0}], 2\hat{ }n]; While[Not[PrimeQ[p]], p−−];
    d = Mod[Hash[{seedSK, 1}], p];
    \[Mu] = Mod[Hash[{seedSK, 2}], q];
    v = Table[Mod[Hash[{seedPK, i}], 2\hat{ }n], {i, 1, n}];
    z = Table[RandomInteger[n\hat{ }2], {i, 1, n}];
    For[i = 1, i <= n,
      While[Mod[(v[[i]] + z[[i]]) d, p] >= Floor[p/n],
        z[[i]] = RandomInteger[n\hat{ }2]];
      i++];
  s = Mod[\[Mu] Mod[(v + z) d, p], q];
  {{p, d, \[Mu]}, {q, v + z, s}}];
```

The execution of such a code will effectively give “true”:

n = 100;
k = Floor[n*0.291];
{sk, pk} = CompAlgGenCPA[n, k];
{Ch, K} = EncapCPA[n, k, pk];
Print[K == DecapCPA[n, k, sk, pk, Ch]]

This code is given by way of illustration because the hash function of the Mathematica software returns a hash of limited size, thus the illustrative example will cease to function for large values of n. For the sake of simplicity, the example generates compressible and non-compressible keys. A compressible key being a key that can be easily compressed.

It will also be noted that, instead of using an exhaustive search, it is possible to use the LLL algorithm in order to divide the modular information and solve the equation wᵢ=d(v′ᵢ+zᵢ) mod p for the unknowns wᵢ, zᵢ under the constraints wᵢ<└p/n┘ and zᵢ<n². This is an alternative public key compression method, the implementation of which will be obvious to a person skilled in the art. This method extending easily for τ>2.

The formulae for expanding sk, obvious to a person skilled in the art, are:

$$s k = \{ p , d , μ \}$$

←{fₚ(Expand(0, seed_sk)), f_{d} (Expand(1, seed_sk)), f_{μ}(Expand(2, seed_sk))}

The functions fₚ,f_{d}, f_{μ} derive the parameters {p, d, μ} from seed_sk.

The formulae for expanding pk are technically more difficult:

$$p k = \{ q , \vec{{v}^{[ n ]}} , \vec{{s}^{[ n ]}} \} = \{ Expand ( 0 , seed\_pk ) , CompressV ( seed\_pk ) , uncompressed \}$$

where the auxiliary algorithm CompressV(seed_pk) requires the following explanation: It is started by deriving \vec{v′^{[n]}}=Expand(1,seed_pk) the identity of R (10-1) from seed_pk (which is public for example). It is also possible to use, for \vec{v′^{[n]}}, a constant common to all the users such as \vec{v′^{[n]}}←π=3.1415 . . . or to generate seed_pk on the basis of the data item PP.

However, in doing so, a problem will be encountered: if the arbitrary value of \vec{v′^{[n]}} is used instead of \vec{v^{[n]}}, the back-calculated \vec{w^{[n]}} will be full size, i.e. potentially greater than └p/n┘ and will therefore not satisfy the constraint Σwᵢ<p.

In order to circumvent this difficulty, \vec{v^{[n]}}: =\vec{v′^{[n]}}+\vec{z^{[n]}} will be used, instead of the original \vec{v′^{[n]}}, by introducing short corrective factors \vec{z^{[n]}}, such that: \vec{v^{[n]}}=Expand(1, seed_pk)+\vec{z^{[n]}}=\vec{v′^{[n]}}+\vec{z^{[n]}}=\vec{w^{[n]}}d⁻¹ mod p.

Thus, it can be ensured that, for every i=1, . . . n, wᵢ<p/n, by absorbing the entropy missing in \vec{z^{[n]}}. The compressed public key pk will therefore be composed in this way: pk={seed_pk, \vec{z^{[n]}},\vec{s^{[n]}}}.

A fourth embodiment provides a noteworthy improvement of the bandwidth of the method of the invention. It consists of a generalization for several vectors at once. The resulting algorithm will be denoted mKEM_{CPA}={mAlgSetUp, mAlgGen_{CPA}, mEncap_{CPA}, mDecap_{CPA}}, where the letter “m” added in front of the name of the algorithm is the acronym of the word “multiple”. For this purpose, a new integer parameter t≥1 is introduced into the description. When t=1, the algorithm mKEM_{CPA} becomes identical to KEM_{CPA}. It is clear to a person skilled in the art that the same transform making it possible to transform KEM_{CPA} and KEM_{CCA} makes it possible to transform mKEM_{CPA} into a CCA-level algorithm mKEM_{CCA}.

In CPA mode, this embodiment has the characteristics: a private key sk with a size of 2tn+t²k=nt(2+0.291t) bits, a public key pk with a size of n²+nkt+k=n²(1+0.291t)+0.291n, an exchanged key with a size of kt=0.291nt bits and an encrypted with a size of n+log₂n bits.

For this, the present invention makes use of a square matrix M with the dimensions t×t. Such a matrix M must have a non-zero determinant. The obvious way to generate such matrices M is to choose them at random until a matrix M with a non-zero determinant is obtained.

Since, in the present invention, the dimension t of the matrix is very small (typically t≤4), such a method proves to be acceptable, suitable and effective.

By way of illustrative example, such a method for generating matrices could be expressed in Mathematica language as follows:

```
GenM := Function[{t, q},
  While[M = RandomInteger[q − 1, {t, t}];
  Mod[Det[M], q] == 0];
  M];
```

An implementation example of such a fourth embodiment mKEM_{CPA} can be described algorithmically by the following operations, relating to the production 120 (mAlgGen_{CPA}) of the pair of keys {sk,pk}, consisting of generating:

$$q {←}^{\$} {P}_{k} ;$$

$$\vec{{p}^{[ t ]}} ← \{ {p}_{1} , … , {p}_{t} \} {←}^{\$} {P}_{n}^{t} with i \neq j ⇒ {p}_{i} \neq {p}_{j} ;$$

$$\vec{{d}^{[ t ]}} ← \{ {d}_{1} … , {d}_{t} \} {←}^{\$} {Z}_{{p}_{1}}^{*} \times … \times {Z}_{{p}_{t}}^{*} ;$$

an invertible matrix M with a dimension of t×t elements of

$${Z}_{q}^{*} ;$$

\vec{v^{[n]}}←{v₁, . . . ,vₙ} such that ∀i,j,0<vᵢ<2n and dⱼvᵢ mod pⱼ<pⱼ/n;

$$\text{?} ← \{ \vec{{v}^{[ n ]}} {d}_{1} mod {p}_{1} , … , \vec{{v}^{[ n ]}} {d}_{t} mod {p}_{t} \} ;$$

$$\text{?} = \{ \vec{{s}_{1}^{[ n ]}} , … , \vec{{s}_{t}^{[ n ]}} \} ← M \cdot \text{?} ;$$

$$sk ← \{ \vec{{p}^{[ t ]}} , \vec{{d}^{[ t ]}} , M \} ;$$

$$pk ← \{ q , \vec{{v}^{[ n ]}} , \text{?} \} .$$

Techniques that make it possible to produce the vector \vec{v^{[n]}} are described later in the present document.

The method for encapsulating 130 (mEncap_{CPA}(n, k, t, pk)) the secret \vec{K^{[t]}} according to this fourth embodiment differs from Encap_{CPA} in that said secret \vec{K^{[t]}} consists of tk bits. Thus, for a public key

$$pk = \{ q , \vec{{v}^{[ n ]}} , \text{?} \} , \vec{{K}^{[ t ]}} ← \{ \vec{{m}^{[ n ]}} \cdot \vec{{s}_{1}^{[ n ]}} mod q , … , \vec{{m}^{[ n ]}} \cdot \vec{{s}_{t}^{[ n ]}} mod q \} ,$$

where

$$\vec{{m}^{[ n ]}} {←}^{\$} {\{ 0 , 1 \}}^{n}$$

has been generated randomly and the encrypted is C←\vec{m^{[n]}}·\vec{v^{[n]}}∈N.

The method for decapsulating 140 (mDecap_{CPA}(n, k, t, sk, pk, C)) the secret \vec{K^{[t]}} takes, as input, a public key pk={q, \vec{m^{[n]}}, [symbol] }, a secret key sk={\vec{p^{[t]}}, \vec{d^{[t]}}, M} and an encrypted C∈N≤n(p−1)<n2ⁿ. Step 142 of said method 140 calculates \vec{K^{[t]}}←M \vec{b^{[t]}} mod q, where \vec{b^{[t]}}←C \vec{d^{[t]}} mod \vec{p^{[t]}}.

In order to clarify the functioning of mKEM_{CPA}, it will be explained why mKEM_{CPA} is perfectly correct.

It is desired to verify that: [symbol] ·\vec{m^{[n]}}=\vec{K^{[t]}}=M·\vec{b^{[t]}}.

For this purpose, the expression [symbol] ·\vec{m^{[n]}} will be developed and it will be verified that, in doing so, M·\vec{b^{[t]}} is indeed obtained:

$$\text{?} \cdot \vec{{m}^{[ n ]}} = {\sum }_{i = 1}^{n} {m}_{i} \vec{{s}_{l}^{[ t ]}} = {\sum }_{i = 1}^{n} {m}_{i} ( M \cdot \vec{{w}_{l}^{[ t ]}} ) = M \cdot {\sum }_{i = 1}^{n} {m}_{i} \vec{{w}_{l}^{[ t ]}}$$

It therefore remains to be demonstrated that

$${\sum }_{i = 1}^{n} {m}_{i} \vec{{w}_{l}^{[ t ]}} = \vec{{b}^{[ t ]}} :$$

$${\sum }_{i = 1}^{n} {m}_{i} \vec{{w}_{l}^{[ t ]}} = {\sum }_{i = 1}^{n} {m}_{i} ( {v}_{i} \vec{{d}^{[ t ]}} mod \vec{{p}^{[ t ]}} ) = \vec{{d}^{[ t ]}} ( {\sum }_{i = 1}^{n} {m}_{i} {v}_{i} ) mod \vec{{p}^{[ t ]}} = \vec{{d}^{[ t ]}} ( \vec{{m}^{[ n ]}} \cdot \vec{{v}^{[ n ]}} ) mod \vec{{p}^{[ t ]}} = \vec{{d}^{[ t ]}} C mod \vec{{p}^{[ t ]}} = \vec{{b}^{[ t ]}}$$

These operations are correct owing to the constraint imposed on dⱼvᵢ mod pⱼ, allowing the values to fall back into Z.

In conjunction with the method 120 (mAlgGen_{CPA}) producing the pair of keys {sk,pk}, different possible embodiments for producing \vec{v^{[n]}} are examined. Thus, it is important to describe the manner in which said component \vec{v^{[n]}} of the public key pk can be generated. Unlike the first embodiment of a KEM according to the invention (KEM_{CPA}), when t>1, \vec{v^{[n]}} must be found during the generation of the keys. When t=1, the value of \vec{v^{[n]}} is withdrawn from \vec{w^{[n]}}, but in the case of mKEM_{CPA} the element \vec{v^{[n]}} must be determined before \vec{w^{[n]}} is calculated. The trouble caused by this modification in the order of the operations is that now the vᵢ are intrinsically non-random, given the additional constraints which are simultaneously imposed on them. Thus, it is important to counter this adverse effect and guarantee that the vᵢ have an increased entropy. Obviously, a choice of an increased t will make the generation of the \vec{v^{[n]}} slower.

A first embodiment example of the production of the vector \vec{v^{[n]}} denoted GenV(t, n, \vec{p^{[t]}}, \vec{d^{[t]}}) can be described algorithmically by the following table:

| 1 | $\vec{{α}^{[ t ]}} ← ⌊ \frac{\vec{{p}^{[ t ]}}}{n} ⌋$ | |
|---|---|---|
| 2 | ϵ ← d₁⁻¹ mod p₁ | |
| 3 | [symbol] ← {d₂ϵ mod p₂, ... , dₜϵ mod pₜ} | |
| 4 | [symbol] ← {(h₁ − d₂)p₁ mod p₂, ... , (hₜ₋₁ − dₜ)p₁ mod pₜ} | |
| 5 | For i ranging from 1 to n | |
| 6 | { | \|\| opening for i |
| 7 | ${w}_{1} {←}^{\$} [ 1 , {α}_{1} ]$ | |
| 8 | vᵢ ← w₁ mod p₁ | |
| 9 | [symbol] ← {vᵢ d₂ mod p₂, ... , vᵢdₜ mod pₜ} | |
| 10 | While ∃ 2 ≤ j ≤ t such that uⱼ₋₁ > αⱼ | |
| 11 | { | \|\| opening while |
| 12 | If (vᵢ ← vᵢ + ϵ) < p₁ then [symbol] ← [symbol] + [symbol] otherwise | |
| 13 | { | \|\| opening if |
| 14 | [symbol] ← [symbol] + [symbol] | |
| 15 | vᵢ ← vᵢ − p₁ | |
| 16 | } | \|\| closure if |
| 17 | For j ranging from 2 to t | |
| 18 | { | \|\| opening for j |
| 19 | If uⱼ₋₁ ≥ pⱼ then uⱼ₋₁ ← uⱼ₋₁ − pⱼ | |
| 20 | } | \|\| closure for j |
| 21 | } | \|\| closure while |
| 22 | } | \|\| closure for i |
| 23 | Return the vector [symbol] | |

By way of illustrative example, such a method GenV(t, n, \vec{p^{[t]}}, \vec{d^{[t]}}) could be expressed in Mathematica language as follows:

```
GenV := Function[{t, n, p, d},
  \[Alpha] = Table[Floor[p[[i]]/n], {i, 1, t}];
  \[Epsilon] = PowerMod[d[[1]], −1, p[[1]]];
  e = u = Range[2, t];
  v = Table[0, {i, 1, n}];
  h = Table[Mod[d[[i + 1]] \[Epsilon], p[[i + 1]]], {i, 1, t − 1}];
  \[Beta] = Table[Mod[h[[i]] − d[[i + 1]] p[[1]], p[[i + 1]]], {i, 1, t − 1}];
  Do[w1 = RandomInteger[{1, \[Alpha][[1]]}];
  v[[i]] = Mod[w1 \[Epsilon], p[[1]]];
  u = Mod[v[[i]] d[[#]], p[[#]]] & /@ e;
  While[Or @@ ((u[[# − 1]] > \[Alpha][[#]]) & /@ e),
    If[(v[[i]] += \[Epsilon]) >= p[[1]], u += \[Beta];
    v[[i]] −= p[[1]], u += h];
    Do[If[u[[j]] >= p[[j + 1]], u[[j]] −= p[[j + 1]]], {j, t − 1}]], {i, n}];
  v];
```

The execution of such a code will effectively give “true”:

{n,t}={40,3};
p = Table[RandomPrime[2\hat{ }n], {i, 1, t}];
d = Table[RandomInteger[{1, p[[i]] − 1}], {i, 1, t}];
GenV[t, n, p, d];
And @@ Flatten[Table[Mod[v[[i]]
d[[j]],p[[j]]]<Floor[p[[j]]/n],{j,1,t},{i,1,n}]]

Which makes it possible to test the set of steps of the algorithm in this way:

```
mAlgGenCPA := Function[{n, k, t},
  q = RandomPrime[2\hat{ }k]; p = { };
  While[Length[p] != t,
  p = Union[Table[RandomPrime[2\hat{ }n], {i, 1, t}]]];
  d = Table[RandomInteger[{1, p[[i]]−1}], {i, 1, t}];
  M = GenM[t, q];
  v = GenV[t, n, p, d];
  w = Table[Mod[v d[[i]], p[[i]]], {i, 1, t}];
  s = Mod[M · w, q];
  {{p, d, M}, {q, v, s}}];
mEncapCPA := Function[{n, k, t, pk},
  {q, v, s} = pk;
  m = Table[RandomInteger[1], {i, 1, n}];
  {Ch = m · v, K = Table[Mod[m · s[[i]], q], {i, 1, t}]}];
mDecapCPA := Function[{n, k, t, sk, pk, Ch},
  q = pk[[1]];
  {p, d, M} = sk;
  b = Mod[Ch d, p];
  K = Mod[ M · b , q]];
```

The execution of such a code will effectively give “true”:

{n, t} = {200, 3};
k = Floor[n*0.291];
{sk, pk} = mAlgGenCPA[n, k, t];
{ch, key} = mEncapCPA[n, k, t, pk];
mDecapCPA[n, k, t, sk, pk, ch] == key

It will be noted that this process of searching for keys is easily parallelizable and can take more from n processors to speed up the search for a factor n. In fact, each vᵢ can be entrusted to a separate processor and generated independently of the others. This statement also applies to the process described in the second embodiment example of the production of \vec{v^{[n]}} which follows.

According to a second embodiment of the production of \vec{v^{[n]}}, the exhaustive search can be considerably reduced by performing several steps, illustrated hereafter, one after another. Since this embodiment makes it possible to respect the size constraint on four elements, it will advantageously also be possible to use this variant to generate keys not revealing the data item q (this embodiment will be described later) for t=2, thus combining both the increased security of the variant not revealing q and the increased bandwidth of the variant t=2.

To do this, a conventional generation of primes

$$\vec{{p}^{[ t ]}} ∈ {P}_{n}^{t}$$

with i≠j⇒pᵢ≠pⱼ is done to start with.

$$( {d}_{1} , {d}_{2} , {d}_{3} , {d}_{4} ) {←}^{\$} [ 1 , ⌊ {p}_{1} / {n}^{3} ⌋ ] \times [ 1 , ⌊ {p}_{2} / {n}^{3} ⌋ ] \times {Z}_{{p}_{3}}^{*} \times {Z}_{{p}_{4}}^{*}$$

To start with, the condition modulo p₁ is guaranteed by construction, by taking a random w₁ such as w₁<p₁/(2n),

$$v = {w}_{1} {d}_{1}^{- 1} mod {p}_{1}$$

is back-calculated, then w₂=vd₂ mod p₂ is determined. w₁ is removed randomly until a w_{z}<p₂/(2n) is obtained.

It can be remarked that, if v is increased by a few units u, this will not ruin the size conditions on w₁ and w₂ because of the judicious choice of d₁, d₂. In fact

$$v = {w}_{1} {d}_{1}^{- 1} mod {p}_{1}$$

means

$$v + u = {w}_{1} {d}_{1}^{- 1} + u = ( {w}_{1} + u {d}_{1} ) {d}_{1}^{- 1} mod {p}_{1} .$$

Thus, it is possible to increase v by a few units until a w₃=vd₃ mod p₃ is found such that w₃<p₃/(2n). It is remarked that the two exhaustive searches made previously are not multiplied but added together. In order to satisfy the constraint also on w₄, the preceding calculations are repeated L times (for a certain parameter L) and a database DB will be built up containing the different values of v obtained in this way denoted v[1], . . . , v[L]. The calculation ends by combining the values in DB by addition v′=v[i]+v[j] until a pair (i,j) is found such that w₄=v′d₄ mod p₄ is satisfied w₄<p₄/(2n).

This calculation can end in three ways:
a v[i] is found such that w₄=v[i]d₄ mod p₄, (type-1 solution, rare);
a pair v′=u[i]+u[j] is found such that w₄=v′d₄ mod p₄<p₄/(2n) is satisfied (type-2 solution, more common because of the birthday paradox);
a pair v′=u[i]−u[j] is found such that w₄=v′d₄ mod p₄<p₄/(2n) is satisfied (type-3 solution, less common than the type-2 solutions) where, in addition, w[i]>w[j] in Z when the quantities w[i], w[j] of which taken modulo all the pᵢ for i=1, . . . , t. This is necessary in order to allow a subtraction in the correct order of the operands in Z making it possible to shorten v′.

If the iteration over L is not sufficient, the iteration should be continued for a wider value of L.

It is important to note that, even if this process has to be repeated for each coordinate of the vector \vec{v^{[n]}}, the database DB can be recycled from one coordinate to another: once a solution has been found for a given coordinate, this solution and/or its components can be taken away (deleted from DB and the resulting database can be used to initiate the search for the following coordinate of \vec{v^{[n]}}, without having to recalculate DB over again. It is then sufficient to continue to enhance DB.

By way of illustrative example, such a method making it possible to generate a coordinate of the vector of \vec{v^{[n]}} could be expressed in Mathematica language as follows:

```
{k, L, w, DB} = {100, 100, {0, 0, 0, 0}, { }};
n = Floor[k/0.291];
p = RandomPrime[2\hat{ }n] & /@ w;
d = RandomInteger[#] & /@ {Floor[p[[1]]/(n\hat{ }3)], Floor[p[[2]]/(n\hat{ }3)],
    p[[3]] − 1, p[[4]] − 1};
u = PowerMod[d[[1]], −1, p[[1]]];
For[i = 1, i <= L,
  While[w[[1]] = RandomInteger[Floor[p[[1]]/(2 n)]];
      v = Mod[w[[1]]*u, p[[1]]];
  w[[2]] = Mod[v d[[2]], p[[2]]]; w[[2]] > p[[2]]/(2 n)];
  w[[3]] = Mod[d[[3]]*v, p[[3]]];
  While[w[[3]] > p[[3]]/(2 n), v++; w[[3]] = Mod[d[[3]]*v, p[[3]]]];
  AppendTo[DB, {w[[4]] = Mod[d[[4]]*v, p[[4]]], v}];
  i++];
For[i = 1, i <= L,
  If[DB[[i, 1]] < p[[4]]/n,
  v = DB[[i, 2]];
  e = Table[Mod[d[[i]]*v, p[[i]]] < p[[i]]/n, {i, 1, 4}];
  Print[“type-1 solution found and tested:”, e]; i = L];
  i++];
For[i = 1, i <= L,
  For[j = i + 1, j <= L,
      If[Mod[DB[[i, 1]] + DB[[j, 1]], p[[4]]] < p[[4]]/n,
      v = DB[[i, 2]] + DB[[j, 2]];
      e = Table[Mod[d[[i]]*v, p[[i]]] < p[[i]]/n, {i, 1, 4}];
      Print[“type-2 solution found and tested:”, e]; i = j = L];
      j++];
  i++];
```

Whatever the solution retained to implement this fourth embodiment of a KEM according to the invention, the choice of t is essential. It will be noted that the parameter t cannot be too large. An argument intuitive to such an inherent limitation is that, if a key with more than n bits is generated, its entropy will be limited in every way (because there will always be a better attack consisting of trying all the possible values of \vec{m^{[n]}} through an exhaustive search). This enacts a first constraint, which is t≤n/k. Given that t must be an integer, it is proposed to take either t=└n/k┘ or t=┌n/k┐. If t=┌n/k┐ is chosen, the resulting key will have to be hashed towards n bits before use. It is noted that it would be appropriate to avoid t>4 because the values chosen for n and k would all be such that └n/k┘=3.

Thus, for t=1, the generation of the keys is immediate for every embodiment revealing the component q in the public key pk. It is also this for every embodiment, described later, not revealing said component q in the public key pk.

For t=2, the generation of the keys is immediate for every embodiment revealing the component q in the public key pk. It remains fast for every embodiment, described later, not revealing said component q in the public key pk. The size of K is sufficient for the majority of practical applications.

For t=3, the generation of the keys is easy for every embodiment revealing the component q in the public key pk. The size of K, however, becomes large and exceeds what is usually required for practical applications.

For t=4, the generation of the keys remains reasonable for every embodiment revealing the component q in the public key pk. However, the size of K is maximized and the ratio between the entropy of K and the number of operations effected starts to decrease.

It is therefore recommended to take t=1, or t=2 or t=3 (which are particularly attractive) depending on the application needs and to reserve the choice t=4 for applications requiring keys as long as possible. It seems that there is no apparent utility in using t>4.

As mentioned previously, the invention provides a fifth embodiment, for which the component q of the public key pk is not revealed and thus to strengthen the robustness of a KEM according to the invention again.

According to a fifth embodiment of a KEM according to the invention, which will be called qLessKEM_{CPA}, it is possible to omit the component q of the public key pk.

According to a first technique for implementing such a qLessKEM_{CPA}, q becomes one of the components of the secret key sk, said keys {sk, pk} being produced within the framework of a method 120 suitable as a result, which will be called qLessAlgGen_{CPA} to differentiate it from the algorithm AlgGen_{CPA} already described in conjunction with the KEM_{CPA}.

As with this latter, the parameters par consist of an integer n chosen or predetermined such that k≤n, k being a security parameter provided by the user. According to a preferred embodiment, n will be chosen in such a way that n>3.44k.

The method 120 for generating the public pk and secret sk keys is a method which can be summarized by the formula {sk,pk}=qLessAlgGen_{CPA}(n, k), this latter being implemented by any electronic device 10-1 to 10-g of said computer system 1, includes a step 121 of producing a second random or pseudorandom data item SS by the random or pseudorandom number generator 13. Such a second random or pseudorandom data item SS makes it possible to derive a set of n positive integers, which will be denoted w₁, . . . , wₙ. The invention provides that the sum of said n integers w₁, . . . , wₙ is limited by a parameter p, advantageously prime.

Thus, by way of embodiment example, such a step 121 consists of the following operations:

$$- ( p , q ) {←}^{\$} {P}_{n} \times {P}_{k} ;$$

$$- ( d , μ ) {←}^{\$} {Z}_{p}^{*} \times {Z}_{q}^{*} ;$$

$$- \vec{{w}^{[ n ]}} {←}^{\$} \{ \vec{{x}^{[ n ]}} ∈ {N}^{n} , \sum {x}_{i} < p \}$$

and such that Σ(μwᵢ mod q)<q.

The formula Σ(μwᵢ mod q)<q must be interpreted as follows: first of all, said computer system 1 calculates the numbers γᵢ=μwᵢ mod q, once the γᵢ have been obtained, the γᵢ are added up as integers without the resultant sum being reduced modulo q.

Step 121 has been described with prime p of n bits. As a variant, p could be chosen such that GCD(d, p)=1 such that d is invertible.

Furthermore, the operation

$$\vec{{w}^{[ n ]}} {←}^{\$} \{ \vec{{x}^{[ n ]}} ∈ {N}^{n} , \sum {x}_{i} < p \}$$

and such as Σ(μwᵢ mod q)<q expressed above can be performed by the implementation of a subroutine called qLessRandSumVec, which can be described algorithmically by the following table:

| | |
|---|---|
| 1 | [symbol] ← Ø |
| 2 | While [symbol] does not contain n distinct elements, do: |
| 3 | { |
| 4 | $\vec{{u}^{[ n ]}} {←}^{\$} {( {Z}_{p}^{*} )}^{n}$ |
| 5 | [symbol] ← Sort ( [symbol] ), i.e. rᵢ ≤ rᵢ₊₁ |
| 6 | w₁ ← r₁ |
| 7 | For i ranging from 2 to n: |
| 8 | { |
| 9 | wᵢ ← rᵢ - rᵢ₋₁ |
| 10 | } |
| 11 | For i ranging from 1 to n: |
| 12 | { |
| 13 | While μ wᵢ mod q > q/n, do wᵢ ← wᵢ + 1 |
| 14 | } |
| 15 | } |
| 16 | Return the vector [symbol] |

By way of illustrative example, such a method qLessRandSumVec generating the vector of \vec{w^{[n]}} could be expressed in Mathematica language as follows:

```
qLessRandSumVec := Function[{p, n, q, \[Mu]}, w = { };
  While[Length[w] != n, r = Sort[Table[RandomInteger[p−1], {i, 1, n}]];
    w = Prepend[Table[r[[i]] − r[[i − 1]], {i, 2, n}], r[[1]]]];
  For[i = 1, i <= n, While[Mod[\[Mu] w[[i]], q] > q/n, w[[i]]++]; i++];
  w];
```

The method 120, denoted qLessAlgGen_{CPA}(n,k), consequently includes a step 122 of producing the pair of secret and public keys {sk, pk} which can consist of implementing the following operations:

$$- \vec{{v}^{[ n ]}} ← \vec{{w}^{[ n ]}} {d}^{- 1} mod p$$

$$- \vec{{s}^{[ n ]}} ← \vec{{w}^{[ n ]}} μ mod q$$

$$\text{-} sk ← \{ q , p , d , μ \}$$

$$- pk ← \{ \vec{{v}^{[ n ]}} , \vec{{s}^{[ n ]}} \} .$$

By way of illustrative example, such a method (120) qLessAlgGen_{CPA}(n, k) could be expressed in Mathematica language as follows:

```
qLessAlgGenCPA :=
  Function[{n, k}, {p, q} = RandomPrime[2\hat{ }#] & /@ {n, k};
  {d, \[Mu]} = RandomInteger[#−1] & /@ {p, q};
  w = qLessRandSumVec[p, n, q, \[Mu]];
  v = Mod[PowerMod[d, −1, p] w, p];
  s = Mod[\[Mu] w, q];
  {{q, p, d, \[Mu]}, {v, s}}];
```

According to this embodiment of a qLessKEM_{CPA} not revealing q in the public key pk, a method 130 for encrypting or encapsulating a secret—which can be summarized by the formulation {C, K}←qLessEncap_{CPA}(n,k,pk)—implemented by any electronic device of a computer system 1, such as the electronic device S (10-2), includes a step 131 of producing a random or pseudorandom data item MM by the random or pseudorandom number generator 13. Such a data item MM making it possible to derive a vector of n integers such as

$$\vec{{m}^{[ n ]}} {←}^{\$} {\{ 0 , 1 \}}^{n} .$$

Since the public key pk (read in step 132) of the electronic device receiving the secret K encapsulated in the form of an encrypted C is expressed in the form pk={\vec{v^{[n]}},\vec{s^{[n]}}} (cf. the step 122 of generating the keys {sk, pk} of the method 110 described previously), the step 133 of generating said encrypted C and the secret K is such that C←\vec{m^{[n]}}·\vec{v^{[n]}}∈N and K←\vec{m^{[n]}}·\vec{s^{[n]}}∈N. It will be noted that neither the calculation of C nor the calculation of K uses modular reductions.

By way of illustrative example, such a method (130) qLessEncap_{CPA}(n, k, pk) could be expressed in Mathematica language as follows:

```
qLessEncapCPA := Function[{n, k, pk}, {v, s} = pk;
  m = Table[RandomInteger[1], {i, 1, n}];
  {Ch = m · v, K = m · s}];
```

According to this embodiment qLessKEM_{CPA} according to the invention, the method 140 for decrypting or decapsulating a secret K, in this case a session key—method 140 which can be summarized by the formulation K←qLessDecap_{CPA}(n, k, sk, C)—implemented by any electronic device of a computer system 1, such as the electronic device R (10-1), in response to the receipt of a message conveying an encrypted C∈N≤n(p−1)<n2ⁿ produced by a third-party electronic device of said computer system 1 according to a previously described encapsulation or encryption method 130, includes a first step 141 of reading, in the data memory 12, the value of the secret key sk={q, p, d, μ} produced previously in step 122 of the method for generating the keys 120 already described in conjunction with FIG. 3, as well as parameters par consisting of the integers n and k such that, advantageously, n>3.44k.

Step 142 of said method 140 consisting of recovering said secret K which it is desired to take from the encrypted C received consists of the operations K←μb mod q, knowing that b←Cd mod p.

By way of illustrative example, such a method (140) qLessDecap_{CPA}(n, k, sk, C) allowing the vector of \vec{w^{[n]}} could be expressed in Mathematica language as follows:

```
qLessDecapCPA := Function[{n, k, sk, pk, Ch};
  {q, p, d, \[Mu]} = sk;
  b = Mod[Ch d, p];
  K = Mod[b \[Mu], q]];
```

The execution of such a code will effectively give “true”:

n = 550;
k = Floor[n*0.291];
{sk, pk} = qLessAlgGenCPA[n, k];
{Ch, K} = qLessEncapCPA[n, k, pk];
Print[K == qLessDecapCPA[n, k, sk, pk, Ch]];

As a variant, the invention provides a second technique resulting in a KEM not revealing q, this variant being denoted qLess2KEM_{CPA}. For example, instead of effecting an exhaustive search on the zᵢ, it has already been specified that it is possible to use the LLL algorithm in the algorithm CompKEM_{CPA} to solve the equation wᵢ=(v′ᵢ+zᵢ)d mod p for the unknowns wᵢ, zᵢ under the constraints wᵢ<└p/n┘ and zᵢ<n². This equation permits on average n solutions because size(wᵢ)+size(zᵢ)>size(p). It is then sufficient to effect an exhaustive search in this space of ≅n solutions until a solution is identified such that sᵢ=wᵢμ mod q<└q/n┘. It follows from this that the electronic sender device S (10-2) no longer needs to calculate K modulo q and q remains unknown by the adversary.

The invention provides a third technique for not revealing q to the adversary, this variant being denoted qLess3KEM_{CPA}. If the compression of the public key pk is not required, the method 120 for generating keys can be modified by generating

$$\vec{{w}^{′ [ n ]}} {←}^{\$} \{ \vec{{x}^{[ n ]}} ∈ {N}^{n} , \sum {x}_{i} < p - {n}^{3} \} .$$

Then, using LLL, solve \vec{s^{[n]}}=\vec{w′^{[n]}}+\vec{z^{[n]}}) μ mod q for small zᵢs (typically zᵢ<n²) and sᵢ<└q/n┘. This equation permits on average n solutions because size(sᵢ)+size(zᵢ)>size(q). Once solved finally, it is possible to define \vec{v^{[n]}}←(\vec{w′^{[n]}}+\vec{z^{[n]}})d⁻¹ mod p=\vec{w^{[n]}}d⁻¹ mod p.

Since

$${\sum }_{i = 1}^{n} {w}_{i}^{′} + {z}_{i} < p - {n}^{3} + {\sum }_{i = 1}^{n} {z}_{i} = p - {n}^{3} + n \times {n}^{2} = p$$

now, it is not necessary to provide p in pk. Since

$${\sum }_{i = 1}^{n} {s}_{i} < q$$

now, it is also not necessary to provide q in pk and the adversary cannot use q for attack purposes.

The invention provides a fourth technique for not revealing q to the adversary, this variant being denoted qLess4KEM_{CPA}. In fact, it is also possible to omit q in the calculation of the secret K by S, 10-2 and to give a potentially negative encrypted C. In this embodiment for encapsulating a secret K, the electronic device S, 10-2 proceeds in two steps: the vector \vec{m^{[n]}} is chosen from \vec{m^{[n]}}∈[−1,0,1]ⁿ in a manner such that K is a positive integer smaller than q. For this purpose, it is only necessary to provide a limit on q and not q. Once K has been calculated, the corresponding encrypted C is calculated in Z, potentially resulting in a signed number the sign of which forms part of the encrypted C. The process of decapsulation is invariant.

To produce K such that K is a positive integer smaller than q, according to a first subordinate embodiment of qLess4KEM_{CPA}, the electronic device S, 10-2 divides the bits of \vec{m^{[n]}} into three parts: one half is chosen to be equal to zero, one quarter is chosen to be equal to 1 and one quarter is chosen to be equal to −1. A lower limit B on q is given to the electronic device S, 10-2 in order that this latter can choose an assortment of keys sᵢ such that K is positive and smaller than q.

According to a second subordinate embodiment of qLess4KEM_{C}PA, it is possible to take \vec{m^{[n]}}∈[0,1]ⁿ then, once the sum K̅←\vec{m^{[n]}}·\vec{s^{[n]}}∈N is known, S (10-2) divides K̅ by one of the sᵢ (for example s₁), calculates the quantity K=K̅−s₁└K̅/s₁┘, verifies that 0≤K≤B and then corrects the encrypted C by subtracting v₁└K̅/s₁┘ from C.

According to a third subordinate embodiment of qLess4KEM_{CPA}, it is possible to take \vec{m^{[n]}}∈[0,1]ⁿ then, once the sum K̅←\vec{m^{[n]}}·\vec{s^{[n]}}∈N is known, S (10-2) subtracts, from K̅, a linear combination of sᵢ denoted Tₛ=

$${\sum }_{i = 1}^{n} {δ}_{i} {s}_{i} ,$$

calculates the quantity K=K̅−Tₛ, verifies that 0≤K≤B and then S (10-2) corrects the encrypted C by subtracting a “mirrorfactor”

$${T}_{v} = {\sum }_{i = 1}^{n} {δ}_{i} {v}_{i}$$

from C.

The invention provides a fifth technique for not revealing q to the adversary, this variant being denoted qLess5KEM_{CPA}. This method uses the exhaustive search making it possible to find the small i such that i×q added to the decapsulated key gives the encapsulated key calculated in integers. This equality being confirmed by a redundancy of the key, denoted h, and added to the encrypted.

By way of illustrative example, such a method qLess5KEM_{CPA} could be expressed in Mathematica language as follows:

```
qLess5AlgGenCPA :=
  Function[{n, k}, {p, q} = RandomPrime[2\hat{ }#] & /@ {n, k};
  {d, \[Mu]} = RandomInteger[#−1] & /@ {p, q};
  w = RandSumVec[p, n];
  v = Mod[PowerMod[d, −1, p] w, p];
  s = Mod[\[Mu] w, q];
  {{q, p, d, \[Mu]}, {v, s}}];
qLess5EncapCPA := Function[{n, k, pk}, {v, s} = pk;
  m = Table[RandomInteger[1], {i, 1, n}];
  {Ch = m · v, K = m · s, h = Hash[K]}];
qLess5DecapCPA := Function[{n, k, sk, pk, Ch, h}, {v, s} = pk;
  {q, p, d, \[Mu]} = sk;
  b = Mod[Ch d, p];
  K = Mod[b \[Mu], q];
  i = 0;
  While[Hash[K + q*i] != h, i++];
  K + q*i];
```

The execution of such a code will effectively give “true”:

n = 2000;
k = Floor[n*0.291];
{sk, pk} = qLess5AlgGenCPA[n, k];
q = sk[[1]];
{Ch, K, h} = qLess5EncapCPA[n, k, pk];
Print[K == qLess5DecapCPA[n, k, sk, pk, Ch, h]];

This method can also be generalized for the case t>1 in an obvious manner.

Finally, the invention provides a sixth technique for not revealing q to the adversary, this variant being denoted qLess6KEM_{CPA}. In fact, it is also possible to omit q in the calculation of the secret K by S, 10-2 and to proceed in the following manner, illustrated hereafter with the parameter t=1. During the encapsulation, calculate K in Z by effecting a simple sum on the integers. Once C has been received by R, 10-1, this latter can find K′=K mod q. To help the electronic device R, 10-1 to find K in Z, the electronic device S, 10-2 sends, with C, the most significant log₂n bits of K, denoted c here. Thus, K=c2^{k}+K′. Knowing K′ and c, the electronic device R, 10-1 can easily calculate K.

By way of illustrative example, such a method qLess6KEM_{CPA} could be expressed in Mathematica language as follows, where the importance of generating the modules q of exactly k bits will be noted:

```
RandSumVec := Function[{p, n}, w = { };
  While[Length[w] != n,
    r = Sort[Table[RandomInteger[p − 1], {i, 1, n}]];
    w = Prepend[Table[r[[i]] − r[[i − 1]], {i, 2, n}], r[[1]]]];
  w];
qLess6AlgGenCPA :=
  Function[{n, k}, {p, q} = RandomPrime[{2\hat{ }(# − 1), 2\hat{ }#}] & /@ {n, k};
  {d, \[Mu]} = RandomInteger[#] & /@ {p, q};
  w = RandSumVec[p, n];
  v = Mod[PowerMod[d, −1, p] w, p];
  s = Mod[\[Mu] w, q];
  {{p, d, \[Mu]}, {q, v, s}}];
qLess6EncapCPA := Function[{n, k, pk}, {q, v, s} = pk;
  m = Table[RandomInteger[1], {i, 1, n}];
  {Ch = m · v, K = m · s, H = (K − Mod[K, 2\hat{ }(k − 1)])/2\hat{ }(k − 1)}];
qLess6DecapCPA := Function[{n, k, sk, pk, Ch, H}, {q, v, s} = pk;
  {p, d, \[Mu]} = sk;
  b = Mod[Ch d, p];
  K = H 2\hat{ }(k − 1) + Mod[b \[Mu] − H 2\hat{ }(k − 1), q]];
```

The execution of such a code will effectively give “true”:

n = 500;
k = Floor[n*0.291];
{sk, pk} = qLess6AlgGenCPA[n, k];
{Ch, K, H} = qLess6EncapCPA[n, k, pk];
K == qLess6DecapCPA[n, k, sk, pk, Ch, H]

Furthermore, given the simple algebraic structure of the invention, it is possible to generalize such an algebraic structure for a variety of rings, groups and finite fields. Such generalizations (translations of one algebraic structure towards another), obvious to a person skilled in the art, are frequently the case in cryptology, as the following references demonstrate:
M. van Dijk, C. Gentry, S. Halevi and V. Vaikuntanathan, “Fully Homomorphic Encryption over the Integers”, Advances in Cryptology—EUROCRYPT 2010, 29th Annual International Conference on the Theory and Applications of Cryptographic Techniques, Monaco/French Riviera, May 30-Jun. 3, 2010. Proceedings, Lecture Notes in Computer Science, vol. 6110, pp. 24-43, Springer, 201;
J. H. Cheon and D. Stehle, “Fully Homomorphic Encryption over the Integers Revisited”, Advances in Cryptology—EUROCRYPT 2015, 2015, Springer Berlin Heidelberg, pp. 513-536;
D. Aggarwal, A. Joux, A. Prakash and M. Santha, “A New Public-Key Cryptosystem via Mersenne Numbers”, Advances in Cryptology—CRYPTO 2018-38th Annual International Cryptology Conference, Santa Barbara, CA, USA, Aug. 19-23, 2018, Proceedings, Part III, Lecture Notes in Computer Science, vol. 10993, pp. 459-482, Springer, 2018;
J. S. Coron, T. Lepoint and M. Tibouchi, “New Multilinear Maps Over the Integers”, Advances in Cryptology—CRYPTO 2015-35th Annual Cryptology Conference, Santa Barbara, CA, USA, Aug. 16-20, 2015, Proceedings, Part I, Lecture Notes in Computer Science, vol. 9215, pp. 267-286, Springer, 2015;
K. Jarvis and M. Nevins, “ETRU: NTRU over the Eisenstein integers”, Des. Codes Cryptogr., vol. 74, no. 1, pp. 219-242, 2015;
Joux, “Fully homomorphic encryption modulo Fermat numbers”, Cryptology ePrint Archive, Report 2019/187, 2019, https://ia.cr/2019/187.

Similarly, the method of the invention could be generalized for non-binary \vec{m^{[n]}}. The algorithms presented in the present invention would then be based on the bounded KP (“Bounded Knapsack Problem”, cf. H. Kellerer, U. Pferschy and D. Pisinger, “The Bounded Knapsack Problem”, Knapsack Problems, 2004, Springer Berlin Heidelberg, Berlin, Heidelberg, pp. 185-209). Such a generalization involves a modification of the size of the \vec{m^{[n]}} and therefore a rebalancing of the parameters and levels of security, as is obvious to a person skilled in the art.

The invention has been described through an example illustrated by FIG. 1, according to which a second electronic device S, 10-2 desires to share the value of a second secret K, which can be given the reference K_{S⇒R}, with a single first electronic device R, 10-1 to use said secret K_{S⇒R} and produce a session key. For this, said secret K_{S⇒R} is encapsulated (method 130) on the basis of the public key pk_{R} of the recipient R, 10-1 (produced by a method 120) in the form of an encrypted C_{S⇒R}. Said recipient R, 10-1 recovers the value of said secret K_{S⇒R} by implementing a method for decapsulating (method 140) said encrypted C_{S⇒R}. The invention moreover provides that methods 130 and 140 can be implemented successively in opposite directions by the two electronic devices S, 10-2 and R, 10-1. Thus, on its turn, the first electronic device R, 10-1, acting as S shares the value of a secret K, which can be given the reference K_{R⇒S}, with the single second electronic device S, 10-2 acting as R to use said secret K_{R⇒S} and produce a session key. Said secret K_{R⇒S} is encapsulated (method 130) in the form of an encrypted C_{R⇒S} on the basis of the public key pks of the recipient S, 10-2. Said recipient S, 10-2 recovers the value of said secret K_{R⇒S} by implementing a method for decapsulating (method 140) said encrypted C_{R⇒S}.

The invention then provides that the future session key used by the two electronic devices S, 10-2 and R, 10-1 can result from a combination of the secrets K_{S⇒R} and K_{R⇒S} securely exchanged in this way. By way of non-limitative examples, said session key can result from the implementation by the two electronic devices S, 10-2 and R, 10-1 of an exclusive-or or a hash function applied to said secrets K_{S⇒R} and K_{R⇒S}.

Finally, it is important to note that the different methods and embodiments can be combined with each other in order to give numerous options for implementation obvious to a person skilled in the art.

By way of non-limitative example, the following method, denoted mCompKEM_{CPA}, provides both a compression of the public keys such as the one provided by CompKEM_{CPA} and an extension to t>1 such as the one provided by mKEM_{CPA}.

Since the methods mCompEncap_{CPA} and mCompDecap_{CPA} are obvious to a person skilled in the art, it will be endeavoured to explain how to compress the pair {sk, pk} in the case t>1.

The step of generating a pair {sk, pk} of secret and public keys, denoted CompAlgGen_{CPA,2}(n, k), corresponding to AlgKeyGen, as well as of publishing said public key pk produced consists of:
generating a second random data item SS by a random number generator 13 of the first electronic device R, 10-1 completing said step, and deriving

$$\{ seed\_pk , seed\_sk \} {←}^{\$} {[ 0 , {2}^{k} - 1 ]}^{2}$$

from it, the seed_pk is public and the seed_sk is kept secret;
producing the compressible secret key sk←{p, d, μ}, where

$$p ∈ {P}_{n} , d ∈ {Z}_{p}^{*} and μ ∈ {Z}_{q}^{*}$$

are derived deterministically from seed_sk;
producing the compressible public key pk←{q, \vec{v′^{[in]}}+\vec{z^{[n]}},\vec{s^{[n]}}}, where:
   q is a prime of k bits derived deterministically from seed_pk;
   \vec{v′^{[n]}}∈[1, 2n−1]ⁿ is derived deterministically from seed_pk;
   \vec{z^{[n]}} is initialized randomly

$$\vec{{z}^{[ n ]}} {←}^{\$} {[ 1 , {n}^{2} - 1 ]}^{n} ;$$

\vec{s^{[n]}} is produced in this way:
   for 1≤i≤n,
      while ∃1≤j≤t, such that

$$( {v}_{i}^{′} + {z}_{i} ) {d}_{j} mod {p}_{j} \geq ⌊ \frac{{p}_{j}}{n} ⌋ , refresh {z}_{i} ← [ 0 , {n}^{2} - 1 ] ;$$

$$∘ \vec{{v}^{[ n ]}} ← \vec{{v}^{′ [ n ]}} + \vec{{z}^{[ n ]}} ;$$

$$∘ \vec{{\vec{{w}^{[ n ]}}}^{[ t ]}} ← \vec{{v}^{[ n ]}} {d}_{1} mod {p}_{1} , … , \vec{{v}^{[ n ]}} {d}_{t} mod {p}_{t} ;$$

$$∘ \vec{{\vec{{s}^{[ n ]}}}^{[ t ]}} = \{ \vec{{s}_{1}^{[ n ]}} , … , \vec{{s}_{t}^{[ n ]}} \} ← M \cdot \vec{{\vec{{w}^{[ n ]}}}^{[ t ]}} ;$$

$$∘ sk ← \{ \vec{{p}^{[ t ]}} , \vec{{d}^{[ t ]}} , M \} ;$$

$$∘ pk ← \{ q , \vec{{v}^{[ n ]}} , \vec{{\vec{{s}^{[ n ]}}}^{[ t ]}} \} .$$

It is easy to see that pk can be compressed into {seed_pk, \vec{z^{[n]}}, \vec{s^{[n]}} }, which makes a considerable memory gain possible.

1. Method for transporting a secret K which can withstand quantum computer attacks, said method being implemented by a computer system containing a first and a second electronic device, said first and second electronic devices each containing a processing unit which cooperates with a data memory and means of communication with the outside world, said first electronic device R being designed to receive and use the previously produced secret K encapsulated by said second electronic device S, said transport method including:
a step of generating and publishing general parameters par of said transport method implemented by the first electronic device R;
a step of generating a pair {sk, pk} of secret and public keys, as well as of publishing said public key produced, said step being implemented by the first electronic device R, said pair of secret and public keys {sk, pk} being produced on the basis of said general parameters par and on the basis of a first random data item produced by a random number generator of said first electronic device R;
a step of encapsulating the secret K in the form of an encrypted C and of transmitting this latter, said step being implemented by said second electronic device S on the basis of said general parameters par, the public key pk of said first electronic device R and a second random data item produced by the random number generator of said second electronic device S;
a step of decapsulating said secret K implemented by said first electronic device R on the basis of said encrypted C, said general parameters par and the pair {sk, pk} of secret and public keys already produced by the first electronic device R;
said transport method being characterized in that said second random data item serves to derive a vector of n integers \vec{m^{[n]}} and in that the step of encapsulating the secret K in the form of an encrypted C and of transmitting this latter consists of implementing two sums having the same indices m₁, . . . ,mₙ, the encrypted C consisting of a first sum such as C←\vec{m^{[n]}} and the secret K consisting of a second sum, called “mirror sum”, such as K←\vec{m^{[n]}}, \vec{s^{[n]}}, said first sum being calculated in a first algebraic structure, said second sum being calculated in a second algebraic structure and the vectors \vec{v^{[n]}} and \vec{s^{[n]}} being extracted from the public key pk of said first electronic device R.

2. Method according to claim 1, in which said first and second algebraic structures are the ring of integers Z.

3. Method according to claim 1, in which said first and second algebraic structures are finite fields.

4. Method according to claim 1, in which said first algebraic structure is the ring of integers Z and said second algebraic structure is a finite field.

5. Method according to claim 1, in which said first algebraic structure is a finite field and said second algebraic structure is the ring of integers Z.

6. Method according to claim 4, in which:
the step of generating and publishing general parameters par consists of determining an integer n such that k≤n, k being a security parameter, par being defined by the pair par={n, k};
the step of generating a pair {sk, pk} of secret and public keys, as well as of publishing said public key pk produced consists of:
using the first random data item in order to derive the following parameters:
an integer p of n bits;
a prime integer q of k bits;
integers d and μ such that
$$( d , μ ) {←}^{\$} {Z}_{p}^{*} \times {Z}_{q}^{*} ;$$
a vector \vec{w^{[n]}} of n positive integers w₁, . . . , wₙ the sum of which is limited by p;
producing the secret key sk←{p, d, μ};
producing the public key pk←{q, \vec{v^{[n]}},\vec{s^{[n]}}}, the vectors \vec{v^{[n]}} and \vec{s^{[n]}} being defined by the two relationships \vec{v^{[n]}}←\vec{w^{[n]}}d⁻¹ mod p and \vec{s^{[n]}}←\vec{w^{[n]}}μ mod q;
the step of encapsulating the secret K consists of using the second random data item in order to produce a vector of n integers \vec{m^{[n]}}, on the basis of which the encrypted C←\vec{m^{[n]}}·\vec{v^{[n]}} and the key K←\vec{m^{[n]}}·\vec{s^{[n]}} mod q are calculated;
the step of decapsulating the secret K consists of recovering the key K such that K←μb mod q, where b←Cd mod p.

7. Method according to claim 6, in which the vector \vec{w^{[n]}}=w₁, . . . , wₙ is produced by the following sequence of operations:
\vec{w^{[n]}}77 Ø;
while said vector \vec{w^{[n]}} does not contain n distinct elements, do:
$$\vec{{u}^{[ n ]}} {←}^{\$} {( {Z}_{p}^{*} )}^{n} ;$$
\vec{r^{[n]}}←Sort (\vec{u^{[n]}}) according to the criterion rᵢ≤rᵢ₊₁, for 1≤i≤n−1;
w₁←r₁ and wᵢ←rᵢ−rᵢ₋₁ for 2≤i≤n.

8. Method according to claim 2, in which:
the step of generating and publishing general parameters par consists of determining an integer n such that k≤n, k being a security parameter, par being defined by the pair par={n, k};
the step of generating a pair {sk, pk} of secret and public keys, as well as of publishing said public key pk produced consists of:
using the first random data item in order to derive the following parameters:
an integer p of n bits;
a prime integer q of k bits;
integers d and μ such that
$$( d , μ ) {←}^{\$} {Z}_{p}^{*} \times {Z}_{q}^{*} ;$$
a vector \vec{w^{[n]}} of n positive integers w₁, . . . , wₙ the sum of which is limited by p and such that
$${\sum }_{i = 1}^{n} ( μ {w}_{i} mod q ) < q ;$$
producing the secret key sk←{p, d, μ};
producing the public key pk←{q,\vec{v^{[n]}},\vec{s^{[n]}}}, the vectors \vec{v^{[n]}} and \vec{s^{[n]}} being defined by the two relationships \vec{v^{[n]}}←\vec{w^{[n]}}d⁻¹ mod p and \vec{s^{[n]}}←\vec{w^{[n]}}μ mod q;
the step (130) of encapsulating the secret K consists of using the second random data item in order to produce a vector of n integers \vec{m^{[n]}}, on the basis of which the encrypted C←\vec{m^{[n]}} and the key K←\vec{m^{[n]}}·\vec{s^{[n]}} are calculated;
the step of decapsulating the secret K consists of recovering (4 the key K such that K←μb mod q, where b←Cd mod p.

9. Method according to claim 4, in which:
the step of generating and publishing general parameters par consists of determining an integer n such that k≤n, k being a security parameter, par being defined by the pair par={n, k};
the step of generating a pair {sk, pk} of secret and public keys, as well as of publishing said public key pk produced consists of:
using the first random data item in order to produce two seeds
$$( seed\_pk , seed\_sk ) {←}^{\$} {[ 0 , {2}^{k} - 1 ]}^{2} ;$$
producing the secret key sk←{p, d, μ}, where
$$p ∈ {P}_{n} , d ∈ {Z}_{p}^{*} and μ ∈ {Z}_{q}^{*}$$
are derived deterministically from seed_sk;
producing the public key pk←{q, \vec{v′^{[n]}}+\vec{z^{[n]}},\vec{s^{[n]}}}, where:
the vector \vec{v′^{[n]}}∈[1, 2ⁿ−1]ⁿ is derived deterministically from seed_pk;
q is a prime number of k bits derived deterministically from seed_pk;
the vector \vec{z^{[n]}} and the vector \vec{s^{[n]}} being produced by the following method:
$$\cdot \vec{{z}^{[ n ]}} {←}^{\$} {[ 1 , {n}^{2} - 1 ]}^{n} ;$$
for 1≤i≤n, do:
while (v′ᵢ+zᵢ) d mod p≥[p/n], refresh
$${z}_{i} {←}^{\$} [ 0 , {n}^{2} - 1 ] ;$$
\vec{s^{[n]}}←μ((\vec{v′^{[n]}}+\vec{z^{[n]}})d mod p) mod q;
compressing the key pk into {seed_pk,\vec{z^{[n]}},\vec{s^{[n]}}};
the step of encapsulating the secret K consists of:
decompressing {seed_pk,\vec{z^{[n]}},\vec{s^{[n]}}} by deriving the vector \vec{v′^{[n]}} from the seed_pk, then forming \vec{v^{[n]}}: =\vec{v′^{[n]}}+\vec{z^{[n]}};
generating, on the basis of the second random data item, a vector of n integers \vec{m^{[n]}}, on the basis of which the encrypted C←\vec{m^{[n]}}·\vec{v^{[n]}} and the key K←\vec{m^{[n]}}·\vec{s^{[n]}} mod q are calculated;
the step of decapsulating the secret K consists of recovering the data items sk:={p, d, μ} on the basis of seed_sk, then recovering the key K such that K←μb mod q, where b←Cd mod p.

10. Method according to claim 6, in which p is prime or such that GCD(d, p)=1.

11. Method according to claim 4, in which:
the step of generating and publishing general parameters par consists of determining an integer n such that k≤n, k being a security parameter, and a non-zero integer t, said general parameters par being the triplet {t, n, k};
the step of generating a pair {sk, pk} of secret and public keys, as well as of publishing said public key pk, consists of producing, on the basis of the first random data item, the following data items:
an integer q of k bits;
a vector
$$\vec{{p}^{[ t ]}} ← \{ {p}_{1} , … , {p}_{t} \} {←}^{\$} {P}_{n}^{t}$$
with i≠j⇒pᵢ≠pⱼ;
a vector
$$\vec{{d}^{[ t ]}} ← \{ {d}_{1} , … , {d}_{t} \} {←}^{\$} {Z}_{{p}_{1}}^{*} \times … \times {Z}_{{p}_{t}}^{*} ;$$
a random invertible matrix M with a dimension of t×t, the elements of which are taken randomly from Z_{q};
a secret key sk←{\vec{p^{[t]}}, \vec{d^{[t]}}, M};
a public key pk←{q, \vec{v^{[n]}}, [symbol] }, the vectors \vec{v^{[n]}} and [symbol] being produced such that:
\vec{v^{[n]}}←{v₁, . . . , vₙ} verifies the condition ∀i,j, 0<vᵢ<2ⁿ and dⱼvᵢ mod pⱼ<pⱼ/n;
$$\vec{{\vec{{s}^{[ n ]}}}^{[ t ]}} = \{ \vec{{s}_{1}^{[ n ]}} , … , \vec{{s}_{t}^{[ n ]}} \} ← M \cdot \vec{{\vec{{w}^{[ n ]}}}^{[ t ]}} ,$$
$$where$$
$$\vec{{\vec{{w}^{[ n ]}}}^{[ t ]}} ← \{ \vec{{v}^{[ n ]}} {d}_{1} mod {p}_{1} , … , \vec{{v}^{[ n ]}} {d}_{t} mod {p}_{t} \} ;$$
the step of encapsulating the secret \vec{K^{[t]}} consists of using the second random data item in order to produce a vector of n integers \vec{m^{[n]}}, on the basis of which the encrypted C←\vec{m^{[n]}}·\vec{v^{[n]}} and the key
$$\vec{{K}^{[ t ]}} := \vec{{m}^{[ n ]}} {\vec{{s}^{[ n ]}}}^{[ t ]} ← \{ \vec{{m}^{[ n ]}} \cdot \vec{{s}_{1}^{[ n ]}} mod q , … , \vec{{m}^{[ n ]}} \cdot \vec{{s}_{t}^{[ n ]}} mod q \}$$
are calculated;
the step of decapsulating the secret \vec{K^{[t]}} consists of recovering the key \vec{K^{[t]}} such that \vec{K^{[t]}}←M \vec{b^{[t]}} mod q, where \vec{b^{[t]}}←C \vec{d^{[t]}} mod \vec{p^{[t]}}.

12. Method according to claim 11, in which t is smaller than or equal to 4.

13. Method according to claim 6, in which n is such that n>3.44k.

14. Method according to claim 1, in which the steps of encapsulating and decapsulating the secret K include applying a one-way function OWF(x) to said secret K to produce a second secret K′=OWF(K) intended to be used for cryptographic purposes.

15. Method according to claim 11, in which the step of encapsulating the secret K includes applying a one-way function OWF(x) to said secret \vec{K^{[t]}} to produce a second secret K′=OWF(\vec{K^{[t]}}) intended to be used for cryptographic purposes.

16. Computer program product containing one or more program instructions that can be executed by the processing unit of a computer, said program instructions being able to be loaded into a memory of said computer and the execution of which by said processing unit causes the implementation of a method according claim 1.

17. Computer-readable storage medium containing the instructions of a computer program product according to claim 16.

18. Computer system containing a plurality of electronic devices each comprising a processing unit and a memory, said memory of each of said electronic devices comprising the program instructions P of a computer program product according to claim 16.
